(19) United States
(12) Patent Application Publication
(10) Pub. No.: US 2021/0336809 A1
(43) Pub. Date: Oct. 28, 2021

(54) API BILLING SYSTEM AND API BILLING MANAGEMENT METHOD

(71) Applicant: Hitachi, Ltd., Tokyo (JP)

(72) Inventors: Tatsuya MAKIE, Tokyo (JP); Hiroshi ARAKAWA, Tokyo (JP); Masayasu ASANO, Tokyo (JP)

(21) Appl. No.: 17/010,701

(22) Filed: Sep. 2, 2020

(30) Foreign Application Priority Data
Apr. 22, 2020 (JP) 2020-075872

(51) Int. Cl. H04L 12/14; G06Q 20/14; H04L 29/06

(52) U.S. Cl. CPC H04L 12/1435; H04L 67/40; G06Q 20/145

(57) ABSTRACT

The billing amount can be flexibly changed according to the resource amount and the value of the data processing resources in an API provider's system platform at the time that the API was provided. An API billing system has an API provider system platform and an API connection platform. In the API billing system, the API provider system platform is configured such that a storage apparatus or a storage controller which controls the storage apparatus, can be added to the device configuration in addition to the API server, and the API provider system platform executes processing of the API requested from the application with a processor which differs according to its device configuration, and the API connection platform calculates the API usage fee based on the specification and utilization history of each device included in the processor upon execution of the processing of the API.

### CROSS-REFERENCE TO RELATED APPLICATION

The present application claims priority from Japanese application JP 2020-075872, filed on Apr. 22, 2020, the contents of which is hereby incorporated by reference into this application.

### TECHNICAL FIELD

The present invention relates to an API billing system and an API billing management method, and can be suitably applied to an API billing system and an API billing management method for API (Application Program Interface) users.

### BACKGROUND ART

In recent years, corporations disclose the API of their own services with an aim for promoting open innovation, expanding existing businesses, and streamlining service development. Here, an API provider normally bills the user of its API according to the user's use of its API. For example, PTL 1 discloses an API billing system, an API billing management method, and an API billing program capable of changing the billing amount, for the use of a certain API, according to the number of uses of that API and the type of application(s) for which that API is used by the user.

### CITATION LIST

### Patent Literature

[PTL 1] Japanese Unexamined Patent Application Publication No. 2019-096060

### SUMMARY OF THE INVENTION

### Problems to be Solved by the Invention

Nevertheless, with the API billing management method disclosed in PTL 1, the fee is determined for the use of a certain API according to the number of uses and the application(s) used by the user, and, if the number of uses and the application(s) used by the user are the same, the usage fee will be the same regardless of the data processing resource amount and the value thereof (value of the data processing resources) in the API provider's system platform at the time that the API was provided. In other words, with the API billing management method disclosed in PTL 1, the usage fee was not flexibly determined according to the data processing resource amount and the value thereof in the API provider's system platform at the time that the API was provided.

Meanwhile, an API provider wishes to change the billing amount depending on the level of the data processing resource amount and the value thereof that were expended for providing the API on the API provider's system platform. For example, as a result of introducing, in the API provider's system platform, an IT infrastructure solution which enables the prompt expansion of performance by reducing the amount of internal processing, and the extent of impact thereof, based on the configuration change in the system platform through the addition or deletion of respectively independent data processing resources in compute nodes, network nodes and storage nodes, even if there are numerous accesses to the API provider's system platform within a given period of time, it is possible to minimize the possibility of the server crashing due to an overload. Nevertheless, since subscription and metered billing based on the number of API calls are generally used in a billing system for billing API users, when an IT infrastructure solution is introduced as described above, it was not possible to bill users by adding the dynamic data processing resource amount and the value thereof.

The present invention was devised in view of the foregoing points, and an object of this invention is to provide an API billing system and an API billing management method capable of flexibly changing the billing amount according to the resource amount and the value of the data processing resources in the API provider's system platform at the time that the API was provided.

### Means to Solve the Problems

In order to achieve the foregoing object, the present invention provides an API billing system, comprising: an API provider system platform having an API server which provides an API; and an API connection platform which mediates an application using the API and the API provider system platform, and manages the API, wherein: the API provider system platform is configured such that a storage apparatus, or a storage controller which controls the storage apparatus, can be added to a device configuration in addition to the API server; the API provider system platform executes processing of the API requested from the application with a processor which differs according to the device configuration of the API provider system platform; and the API connection platform calculates an API usage fee for use of the API by the application based on a specification and a utilization history of each device included in the processor upon execution of the processing of the API.

Moreover, in order to achieve the foregoing object, the present invention additionally provides an API billing management method to be performed by an API billing system including an API provider system platform having an API server which provides an API, and an API connection platform which mediates an application using the API and the API provider system platform, and manages the API, wherein the API provider system platform is configured such that a storage apparatus, or a storage controller which controls the storage apparatus, can be added to a device configuration in addition to the API server, and wherein API billing management method comprises: an API processing step of the API provider system platform executing processing of the API requested from the application with a processor which differs according to the device configuration of the API provider system platform; and an API usage fee calculation step of the API connection platform calculating an API usage fee for use of the API by the application based on a specification and a utilization history of each device included in the processor upon execution of the processing of the API.

### Advantageous Effects of the Invention

According to the present invention, it is possible to flexibly change the billing amount according to the resource amount and the value of the data processing resources in the API provider's system platform at the time that the API was provided.

Objects, configurations and effects other than those described above will become apparent from the following description of embodiments for working the present invention.

### BRIEF DESCRIPTION OF DRAWINGS

FIG. 1 is a block diagram showing a schematic configuration of the API billing system 1 according to an embodiment of the present invention.

FIG. 2 is a block diagram showing a configuration example of the API provider system platform 100 and the API connection platform 200 in the API billing system 1.

FIG. 3 is a sequence diagram showing a processing routine example of the overall processing in the API providing service.

FIG. 4 is a block diagram showing a processing image of the first API processing performed by the processor 1.

FIG. 5 is a sequence diagram showing a processing routine example of the first API processing performed by the processor 1.

FIG. 6 is a block diagram showing a processing image of the second API processing performed by the processor 1.

FIG. 7 is a sequence diagram showing a processing routine example of the second API processing performed by the processor 1.

FIG. 8 is a block diagram showing a processing image of the first API processing performed by the processor 2.

FIG. 9 is a sequence diagram (part 1) showing a processing routine example of the first API processing performed by the processor 2.

FIG. 10 is a sequence diagram (part 2) showing a processing routine example of the first API processing performed by the processor 2.

FIG. 11 is a block diagram showing a processing image of the second API processing performed by the processor 2.

FIG. 12 is a sequence diagram (part 1) showing a processing routine example of the second API processing performed by the processor 2.

FIG. 13 is a sequence diagram (part 2) showing a processing routine example of the second API processing performed by the processor 2.

FIG. 14 is a block diagram showing a processing image of the first API processing performed by the processor 3.

FIG. 15 is a sequence diagram (part 1) showing a processing routine example of the first API processing performed by the processor 3.

FIG. 16 is a sequence diagram (part 2) showing a processing routine example of the first API processing performed by the processor 3.

FIG. 17 is a block diagram showing a processing image of the second API processing performed by the processor 3.

FIG. 18 is a sequence diagram (part 1) showing a processing routine example of the second API processing performed by the processor 3.

FIG. 19 is a sequence diagram (part 2) showing a processing routine example of the second API processing performed by the processor 3.

FIG. 20 is a block diagram showing a processing image of the third API processing performed by the processor 3.

FIG. 21 is a sequence diagram (part 1) showing a processing routine example of the third API processing performed by the processor 3.

FIG. 22 is a sequence diagram (part 2) showing a processing routine example of the third API processing performed by the processor 3.

FIG. 23 is a block diagram showing a processing image of the fourth API processing performed by the processor 3.

FIG. 24 is a sequence diagram showing a processing routine example of the fourth API processing performed by the processor 3.

FIG. 25 is a flowchart showing a processing routine example of the API usage fee determination processing.

FIG. 26 is a diagram showing an example of the API usage fee display screen 510.

FIG. 27 is a diagram showing an example of the API request history management table 251.

FIG. 28 is a diagram showing an example of the API specification management table 252.

FIG. 29 is a diagram showing an example of the service level management table 253.

FIG. 30 is a diagram showing an example of the constant information management table 254.

FIG. 31 is a diagram showing an example of the CPU specification management table 255.

FIG. 32 is a diagram showing an example of the memory specification management table 256.

FIG. 33 is a diagram showing an example of the server operation history management table 257.

FIG. 34 is a diagram showing an example of the server specification management table 258.

FIG. 35 is a diagram showing an example of the server utilization history management table 259.

FIG. 36 is a diagram showing an example of the processor management table 151.

FIG. 37 is a diagram showing an example of the write-through coefficient management table 152.

FIG. 38 is a diagram showing an example of the read direct transfer coefficient management table 153.

FIG. 39 is a diagram showing an example of the write direct transfer coefficient management table 154.

FIG. 40 is a diagram showing an example of the server operation history management table 161.

FIG. 41 is a diagram showing an example of the server specification management table 162.

FIG. 42 is a diagram showing an example of the server utilization history management table 163.

FIG. 43 is a diagram showing an example of the CPU specification management table 164.

FIG. 44 is a diagram showing an example of the memory specification management table 165.

FIG. 45 is a diagram showing an example of the FBOF operation history management table 171.

FIG. 46 is a diagram showing an example of the FBOF specification management table 172.

FIG. 47 is a diagram showing an example of the FBOF utilization history management table 173.

FIG. 48 is a diagram showing an example of the CPU specification management table 174.

FIG. 49 is a diagram showing an example of the DKC operation history management table 181.

FIG. 50 is a diagram showing an example of the DKC specification management table 182.

FIG. 51 is a diagram showing an example of the DKC utilization history management table 183.

FIG. 52 is a diagram showing an example of the CPU specification management table 184.

FIG. 53 is a diagram showing an example of the memory specification management table 185.

### DESCRIPTION OF EMBODIMENTS

An embodiment of the present invention is now explained with reference to the appended drawings. The following descriptions and drawings are merely examples for explaining the present invention, and certain descriptions and drawings have been omitted or simplified as needed in order to clarify the explanation. The present invention can also be worked in various other modes. Unless specifically limited herein, each of the constituent elements may be singular or plural.

There may be cases where the position, size, shape, and range of each of the constituent elements shown in the drawings do not represent the actual position, size, shape, and range in order to facilitate the understanding the invention. Thus, the present invention is not necessarily limited to the position, size, shape, and range disclosed in the drawings.

While various types of information are explained below using expressions such as “table”, “list”, and “queue”, such various types of information may also be expressed using other data structures. In order to indicate that information is not dependent on a data structure, “XX table”, “XX list” and the like may be sometimes referred to as “XX information”. While expressions such as “identifying information”, “identifier”, “name”, “ID”, and “number” are used in the explanation of identifying information, these expressions may be mutually substituted.

When there are multiple constituent elements having the same or similar function, explanation may be provided by appending a different suffix to the same reference numeral. Nevertheless, when there is no need to differentiate the multiple constituent elements, explanation may be provided upon omitting the suffix.

Moreover, while the processing to be performed by executing programs is explained below, since a program performs predetermined processing while using a storage resource (for example, memory) and/or an interface device (for example, communication port) as needed as a result of being executed by a processor (for example, CPU (Central Processing Unit) or GPU (Graphics Processing Unit)), the subject of processing may also be the processor. Similarly, the subject of processing to be performed by executing programs may also be a controller, a device, a system, a computer, or a node equipped with a processor. The subject of processing to be performed by executing programs will suffice so as long as it is a computation unit, and may include a dedicated circuit (for example, FPGA (Field-Programmable Gate Array) or ASIC (Application Specific Integrated Circuit)) to perform specific processing.

The programs may also be installed in a device, such a computer, from a program source. The program source may be, for example, a program distribution server or a computer-readable storage media. When the program source is a program distribution server, the program distribution server includes a processor and a storage resource for storing the programs to be distributed, and the process of the program distribution server may distribute the programs to be distributed to another computer. Moreover, in the following explanation, two or more programs may be realized as one program, and one program may be realized as two or more programs.

### (1) Configuration

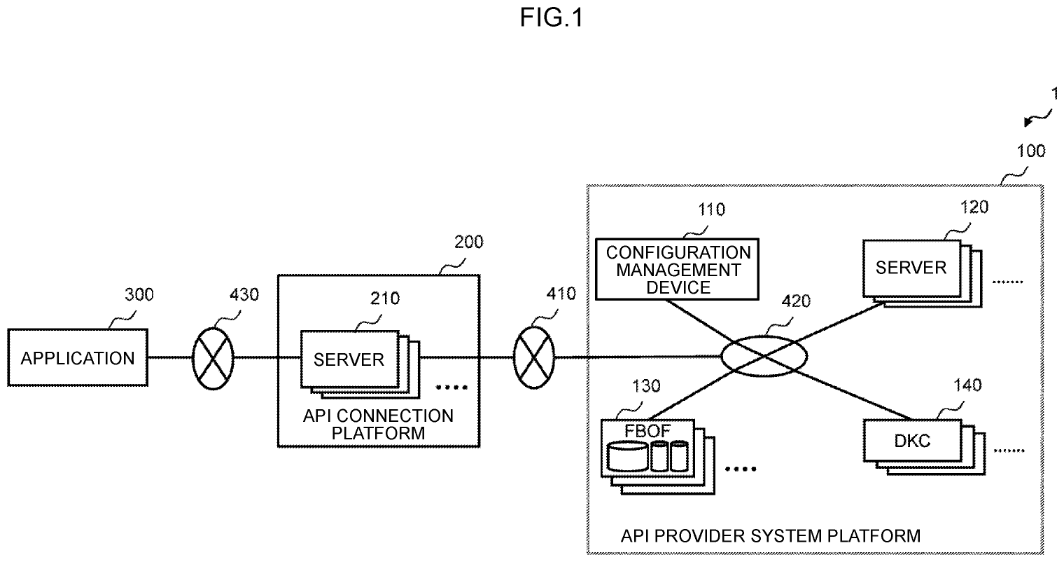

FIG. 1 is a block diagram showing a schematic configuration of the API billing system 1 according to an embodiment of the present invention. The API billing system 1 according to this embodiment is a system that offers an API providing service of providing an API to a user-side application 300, and determines a usage fee (billing amount) of the API according to the resource amount and the value of the data processing resources in the API provider's system platform at the time that the API was provided. As shown in FIG. 1, the API billing system 1 comprises an API provider system platform 100 and an API connection platform 200 connected via a network 410.

The API provider system platform 100 is a system platform which provides the API, and comprises a configuration management device 110, a server 120, an FBOF 130, and a DKC 140 which are communicably connected to each other via a network 420. The API provider system platform 100 is configured so that it can introduce the IT infrastructure solution described in paragraph [0005], and is specifically configured so that the server 120, the FBOF 130, and the DKC 140 can be respectively expanded.

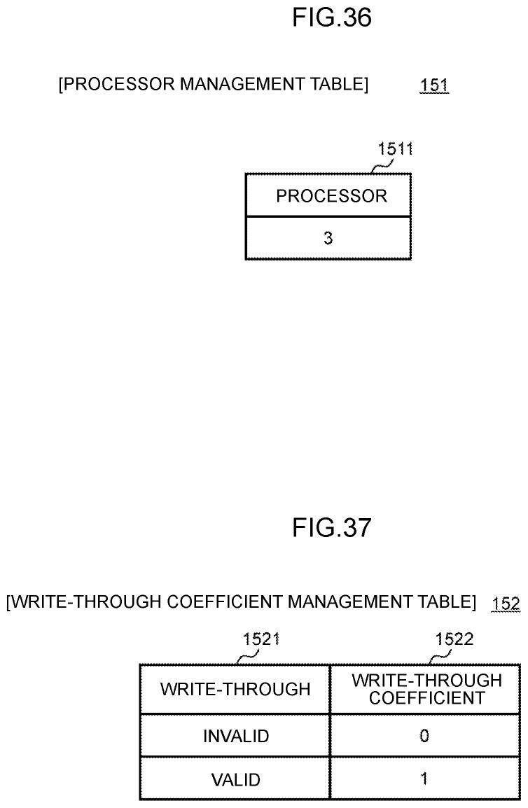

The configuration management device 110 mainly manages the device configuration in the API provider system platform 100. While the API provider system platform 100 is configured by including at least the server 120, which is an API server, in addition to the configuration management device 100, it may also adopt various other device configurations by adding the FBOF 130, or by adding the FBOF 130 and the DKC 140. Moreover, the server 120, the FBOF 130, and the DKC 140 are respectively expandable. Furthermore, the API provider system platform 100 executes processing related to the API (API processing) with processors (processor 1 to processor 3) according to the various device configurations. Specifically, in the API provider system platform 100, when the device configuration other than the configuration management device 110 is only the server 120, the “processor 1” executes the API processing, when the device configuration other than the configuration management device 110 is the server 120 and the FBOF 130, the “processor 2” executes the API processing, and when the device configuration other than the configuration management device 110 is the server 120, the FBOF 130 and the DKC 140, the “processor 3” executes the API processing. Information of the processor 1 to the processor 3 corresponding to the device configuration is managed with a processor management table 151 (refer to FIG. 36) retained in the configuration storage unit 112 of the configuration management device 110.

The server 120 is an API server, and performs the overall control in the API provider system platform 100. While the details will be described later, the server 120 executes the API processing according to a request for the received API, and returns a response to the request.

The FBOF 130 is an FBOF (Fabric-attached Bunch Of Flash), and is a storage apparatus which stores the data to be referenced by the API and the data to be updated with the API. The FBOF 130 can be connected to an InfiniBand or Ethernet (registered trademark) network, and is compatible with the NVMe (Non-Volatile Memory Express) protocol which focuses on performance. Note that, in this embodiment, while the FBOF 130 is compatible with a direct transfer function (read direct transfer function, write direct transfer function) which performs a direct data transfer between the server 120 and the FBOF 130 without going through the DKC 140, the storage apparatus equipped in the API provider system platform of the API billing system according to the present invention is not necessarily limited to this kind of FBOF 130, and may also be an FBOF which is not compatible with the direct transfer function, or another disk system or the like.

The DKC 140 is a storage controller which executes drive control, command processing from the host, and data transfer and the like, and controls the FBOF 130 according to instructions from the server 120.

The API connection platform 200 is a system platform that manages the API between the API provider system platform 100 which provides the API and the application 300 which uses the API, and is configured by comprising an expandable server 210. The API connection platform 200 is communicably connected to the application 300 via a network 430, and communicably connected to the API provider system platform 100 via the network 410.

The application 300 is an API user-side application. The application 300 can use an API by sending a request for the API that it wishes to use to the API billing system 1 (API connection platform 200), and receiving a response to the request from the API billing system 1 (API connection platform 200).

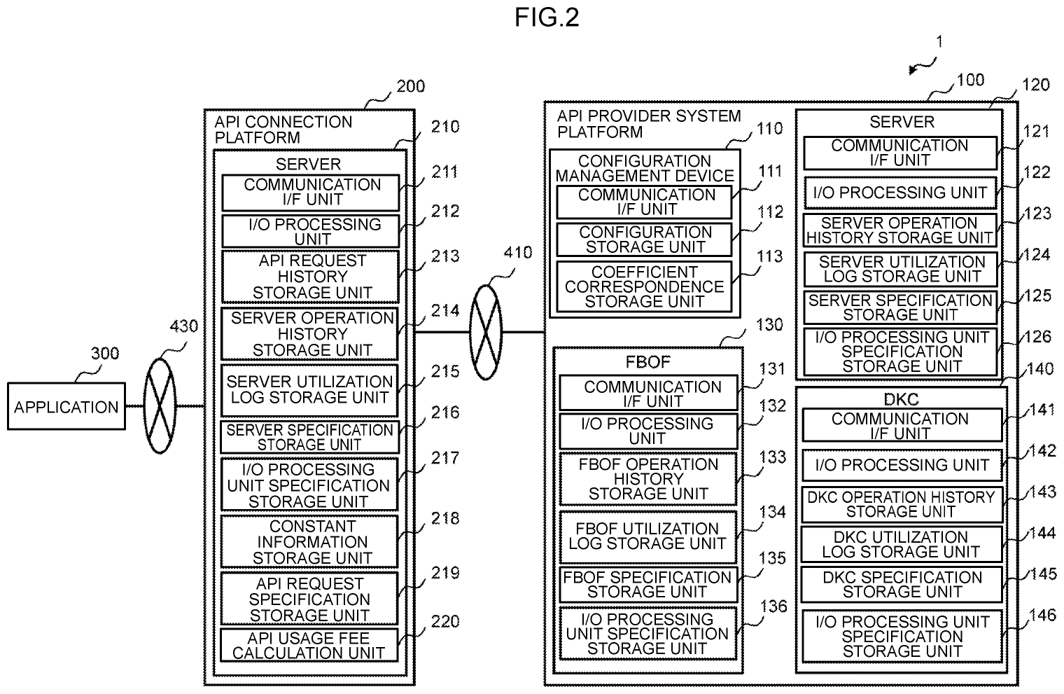

FIG. 2 is a block diagram showing a configuration example of the API provider system platform 100 and the API connection platform 200 in the API billing system 1.

As shown in FIG. 2, in the API provider system platform 100, the configuration management device 110 comprises a communication I/F unit 111, a configuration storage unit 112, and a coefficient correspondence storage unit 113. The server 120 comprises a communication I/F unit 121, an I/O processing unit 122, a server operation history storage unit 123, a server utilization log storage unit 124, a server specification storage unit 125, and an I/O processing unit specification storage unit 126. The FBOF 130 comprises a communication I/F unit 131, an I/O processing unit 132, an FBOF operation history storage unit 133, an FBOF utilization log storage unit 134, an FBOF specification storage unit 135, and an I/O processing unit specification storage unit 136. The DKC 140 comprises a communication I/F unit 141, an I/O processing unit 142, a DKC operation history storage unit 143, a DKC utilization log storage unit 144, a DKC specification storage unit 145, and an I/O processing unit specification storage unit 146.

Moreover, in the API connection platform 200, the server 210 comprises a communication I/F unit 211, an I/O processing unit 212, an API request history storage unit 213, a server operation history storage unit 214, a server utilization log storage unit 215, a server specification storage unit 216, an I/O processing unit specification storage unit 217, a constant information storage unit 218, an API request specification storage unit 219, and an API usage fee calculation unit 220.

The detailed explanation of the respective parts of the API provider system platform 100 and the API connection platform 200 shown in FIG. 2 will be provided as needed in the explanation of the processing and management tables described later.

### (2) Processing in the API Providing Service

The processing to be executed by the API billing system 1 according to this embodiment is now explained. The API billing system 1 according to this embodiment, in response to a request for the API received from the user-side application 300 in the API providing service, performs the processing with the target API and returns a response, and presents a billing amount for the use of the API (API usage fee) and the details thereof to the application 300. Note that the API, which is provided by the API provider system platform 100 of the API billing system 1 and usable from the application 300, includes a reference system API and an update system API, and when the application 300 requests the use of the reference system API which refers to the data, a request for the reference system API is sent from the application 300, and the API billing system 1 that received the foregoing request acquires the data to be referred to by the reference system API from the storage device (specifically, cache of the server 120 or the DKC 140, or the FBOF 130) of the API provider system platform 100 (API processing), and returns, to the application 300, a response to the request by including the acquired data. Moreover, when the application 300 requests the use of the update system API which updates the data, a request for the update system API, which includes the updated data of the designated data, is sent from the application 300, and the API billing system 1 that received the foregoing request updates the data designated by the update system API, based on the updated data, in the storage device (specifically, cache of the server 120 or the DKC 140, or the FBOF 130) of the API provider system platform 100, and returns, to the application 300, a response to the request.

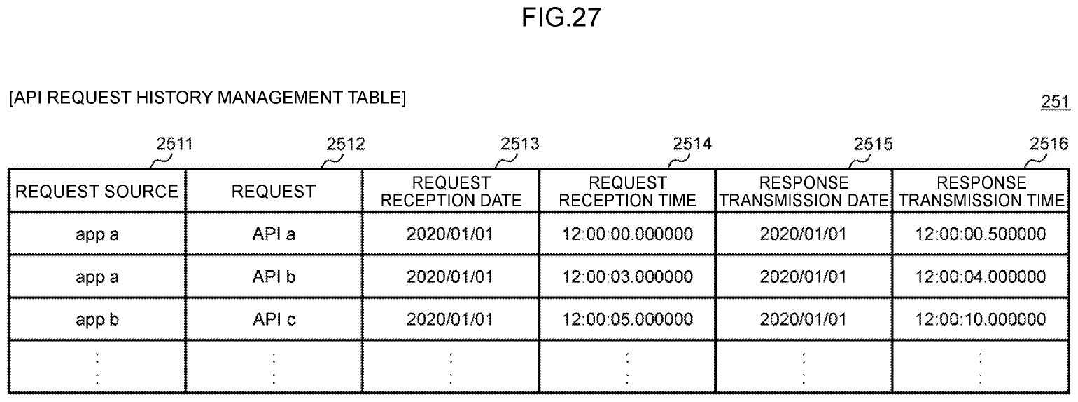

Note that, at the time that the processing related to the API providing service is executed, the API billing system 1 may refer to, search, read from, or write in the management table retained in the respective storage units of the API provider system platform 100 and the API connection platform 200. With regard to each of these management tables, specific examples are collectively illustrated in FIG. 27 to FIG. 53 described later.

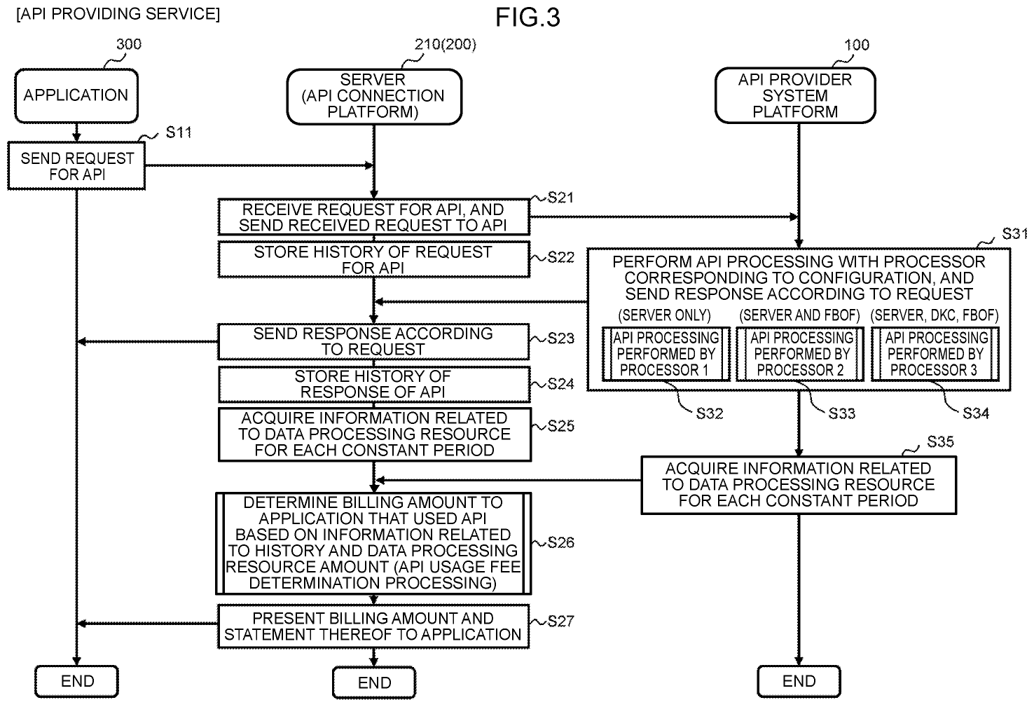

FIG. 3 is a sequence diagram showing a processing routine example of the overall processing in the API providing service.

According to FIG. 3, foremost, the user-side application 300 sends, to the API connection platform 200, a request for an arbitrary API provided by the API provider system platform 100 (step S11).

Next, in the API connection platform 200, the communication I/F unit 211 of the server 210 receives the request sent from the application 300 in step S11, and sends the received request to the API provider system platform 100 (step S21).

Furthermore, in the API connection platform 200, the I/O processing unit 212 of the server 210 stores, in the API request history storage unit 213, a history of the request received in step S21 (step S22). More specifically, information related to the request received in step S21 is recorded in the API request history management table 251 (refer to FIG. 27) retained in the API request history storage unit 213.

Next, in the API provider system platform 100, when the communication I/F unit 121 of the server 120 receives the request sent from the API connection platform 200 in step S21, the processor corresponding to the device configuration of the API provider system platform 100 executes the API processing according to the request, and the communication I/F unit 121 of the server 120 sends a response to the request to the API connection platform 200 (step S31). Note that, when the received request is for an update system API, only a reply to the request needs to be sent as the response, but when the received request is for a reference system API, the data to be referenced by the API must also be sent as the response.

In step S31, specifically, when the device configuration is only the server 120, the API processing is performed by the processor 1 (step S32), when the device configuration is the server 120 and the FBOF 130, the API processing is performed by the processor 2 (step S33), and when the device configuration is the server 120, the FBOF 130 and the DKC 140, the API is performed by the processor 3 (step S34). The processing contents of steps S32 to S34 will be explained in detail separately as the API processing.

Next, in the API connection platform 200, the communication I/F unit 211 of the server 210 receives the response sent from the API provider system platform 100 based on the execution of step S31 (any one of steps S32 to S34), and sends the received response to the application 300 (step S23).

Furthermore, in the API connection platform 200, the I/O processing unit 212 of the server 210 stores the history of the response sent in step S23 in the API request history storage unit 213 (step S24). More specifically, information related to the response sent in step S23 is recorded in the record of the API request history management table 251 in which information related to the request was recorded in step S22.

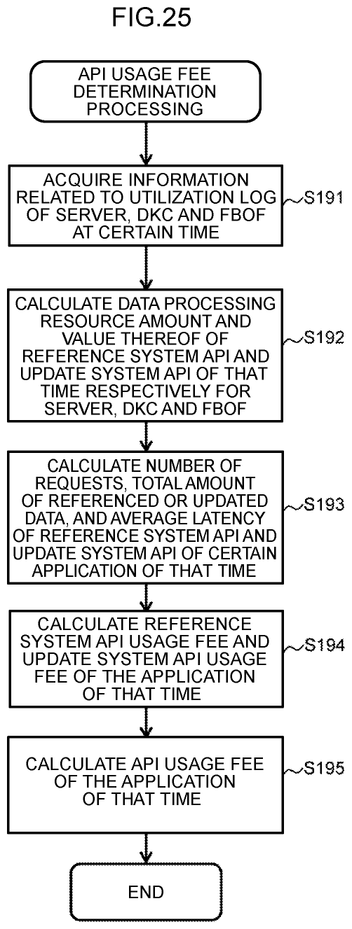

Meanwhile, in the API connection platform 200, the server 210 acquires, for each constant period, prescribed information related to the data processing resources in the API connection platform 200 (step S25). Note that, in FIG. 3, while step S25 is indicated after step S24, since step S25 is processing that is executed for each constant period, step S25 may also be executed at a timing that is before step S24. The “prescribed information related to data processing resources” is information required for calculating the data processing resource amount and the value thereof (resource amount of data processing resources and value of data processing resources), and the details thereof will be described later in the explanation of the API usage fee determination processing (refer to FIG. 25).

Moreover, similar to step S25, in the API provider system platform 100 also, for example, the server 120 acquires the “prescribed information related to data processing resources” in the respective components (server 120, FBOF 130, DKC 140) of the API provider system platform 100 (step S35), and sends the acquired “prescribed information related to data processing resources” to the API connection platform 200. Note that, in FIG. 3, while step S35 is indicated after step S31, since step S35 is processing that is executed for each constant period, step S35 may also be executed at a timing that is before step S31.

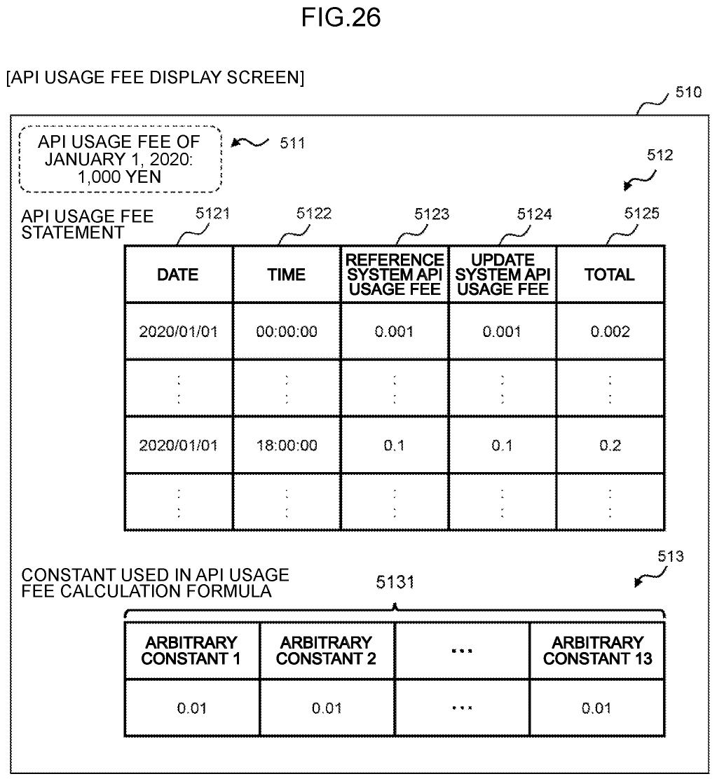

After the processing of step S25 and step S35, in the API connection platform 200, the API usage fee calculation unit 220 of the server 210 performs the API usage fee determination processing (step S26). While the details will be explained later with reference to FIG. 26 and other diagrams, in the API usage fee determination processing of step S26, the API usage fee calculation unit 220 calculates the billing amount (API usage fee) to be billed to the application 300 that used the API based on the history stored in step S22 and step S24, the prescribed information related to data processing resources in the API connection platform 200 acquired in step S25, and the prescribed information related to data processing resources in the API provider system platform 100 acquired in step S35.

Finally, the API usage fee calculation unit 220 of the server 210 presents, to the application 300, the API usage fee calculated in the API usage fee determination processing of step S26, and the information (statement) that was used in the calculation (step S27). While there is no particular limit in the method of presentation, FIG. 26 described later shows, as an example, an API usage fee display screen 510 which displays the API usage fee and the statement thereof on a GUI.

### (2-1) API Processing Performed by the Processor 1

The API processing performed by the processor 1 shown in step S32 of FIG. 3 is now explained in detail.

### (2-1-1) First API Processing

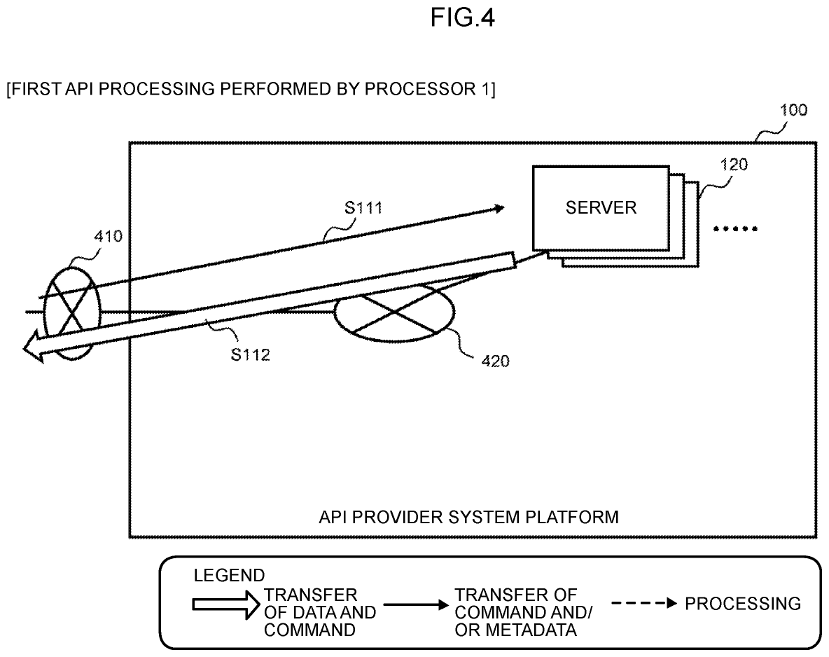

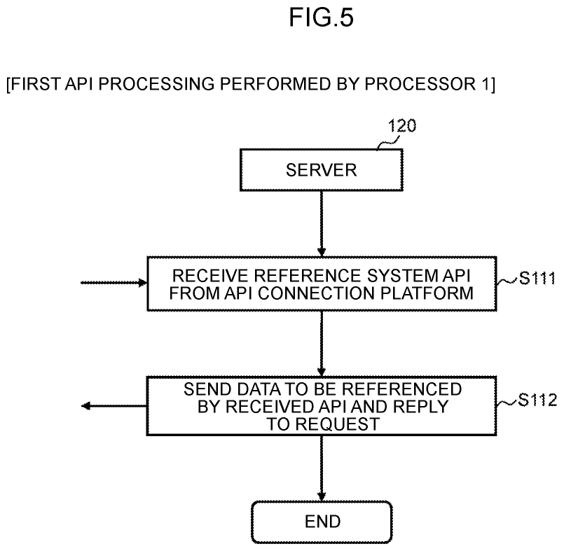

FIG. 4 is a block diagram showing a processing image of the first API processing performed by the processor 1, and FIG. 5 is a sequence diagram showing the processing routine thereof.

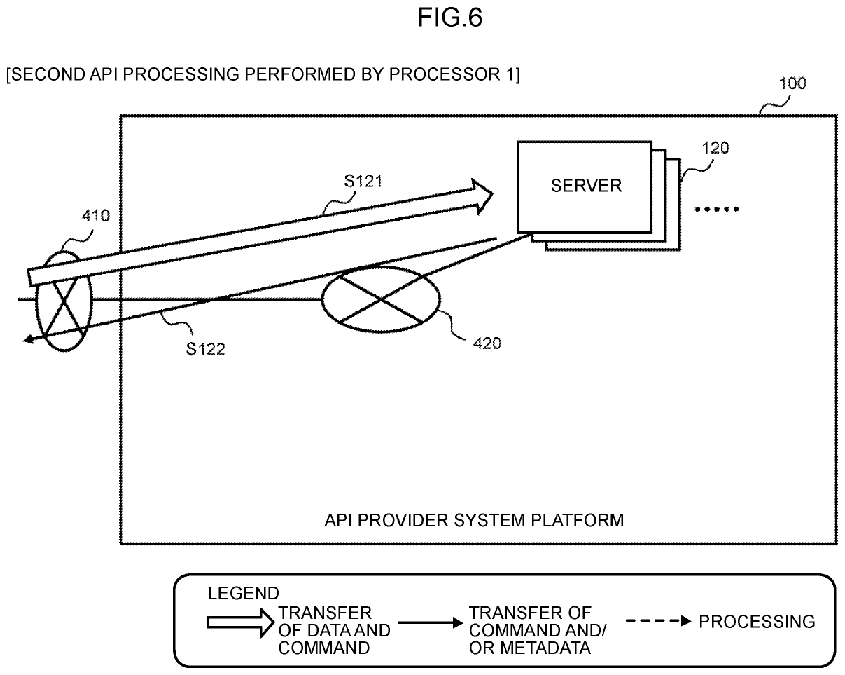

In FIG. 4, the procedure for transferring data and commands between devices, the procedure for transferring commands and/or metadata between devices, and the procedure for executing processing within devices are shown with arrows of different modes of display, and the step number assigned to the respective procedures corresponds to the step number of the processing (procedure) shown in the sequence diagram of FIG. 5. This kind of display method of FIG. 4 and FIG. 5 is also the same for the explanatory diagrams (FIG. 6 to FIG. 24) of the other API processing described later, and redundant explanations will be omitted.

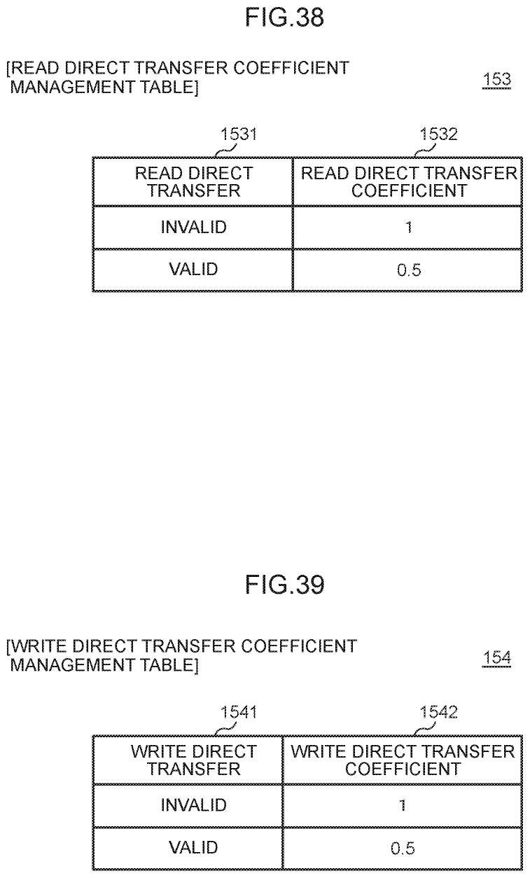

As shown in the device configuration of the API provider system platform 100 of FIG. 4, the API processing performed by the processor 1 is executed by the server 120. Of the API processing performed by the processor 1, the first API processing is the API processing that is executed when the request received from the API connection platform 200 is for a reference system API and the read direct transfer function is set to invalid. When the read direct transfer function is set to invalid, as shown in the read direct transfer coefficient management table 153 of FIG. 38, the read direct transfer coefficient is set to “1”. The same applies below, and redundant explanations will be omitted.

Note that, in the explanation of the other API processing to be described later with reference to FIG. 6 to FIG. 24, unless the setting is specified, let it be assumed that the read direct transfer function and the write direct transfer function have been set to invalid.

The processing routine of the first API processing performed by the processor 1 is now explained with reference to FIG. 5.

According to FIG. 5, foremost, in response to the API connection platform 200 having sent the request received from the application 300 to the API provider system platform 100 in step S21 of FIG. 3, the server 120 of the API provider system platform 100 receives the request (in this example, for a reference system API) from the API connection platform 200 (step S111).

Next, the server 120 acquires, from the server 120, the data to be referenced by the reference system API received in step S111, and sends the acquired data and the information indicating the reply to the request of step S111 to the API connection platform 200 as the response to the request (step S112).

As a result of the processing shown in FIG. 5 being performed in the manner described above, the API provider system platform 100 comprising the device configuration corresponding to the processor 1 can execute the API processing of referencing data according to the request and return the response to the request to the API connection platform 200 when the read direct transfer function has been set to invalid.

### (2-1-2) Second API Processing

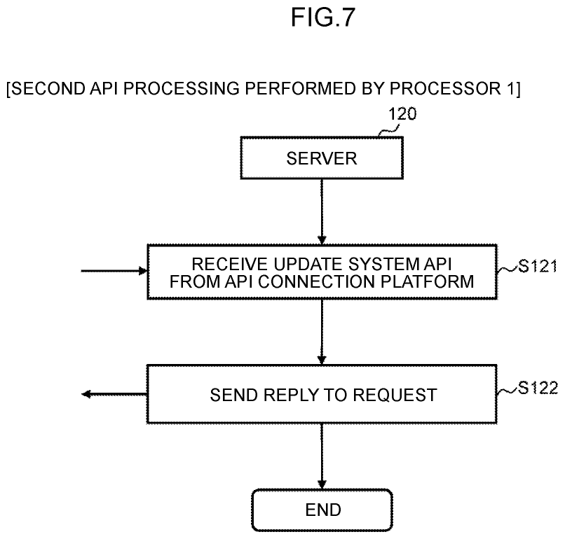

FIG. 6 is a block diagram showing a processing image of the second API processing performed by the processor 1, and FIG. 7 is a sequence diagram showing the processing routine thereof.

As shown in the device configuration of the API provider system platform 100 of FIG. 6, the API processing performed by the processor 1 is executed by the server 120. Of the API processing performed by the processor 1, the second API processing is the API processing that is executed when the request received from the API connection platform 200 is for an update system API and the write direct transfer function is set to invalid. When the write direct transfer function is set to invalid, as shown in the write direct transfer coefficient management table 154 of FIG. 39, the write direct transfer coefficient is set to “1”. The same applies below, and redundant explanations will be omitted.

The processing routine of the second API processing performed by the processor 1 is now explained with reference to FIG. 7.

According to FIG. 7, foremost, in response to the API connection platform 200 having sent the request received from the application 300 to the API provider system platform 100 in step S21 of FIG. 3, the server 120 of the API provider system platform 100 receives the request (in this example, for an update system API) from the API connection platform 200 (step S121).

Next, the server 120 updates, within the server 120, the data which was designated by the update system API received in step S121, and, after the data has been updated, sends the information indicating the reply to the request of step S121 to the API connection platform 200 as the response to the request (step S122).

As a result of the processing shown in FIG. 7 being performed in the manner described above, the API provider system platform 100 comprising the device configuration corresponding to the processor 1 can execute the API processing of updating data according to the request and return the response to the request to the API connection platform 200 when the write direct transfer function has been set to invalid.

### (2-2) API Processing Performed by the Processor 2

The API processing performed by the processor 2 shown in step S33 of FIG. 3 is now explained in detail.

### (2-2-1) First API Processing

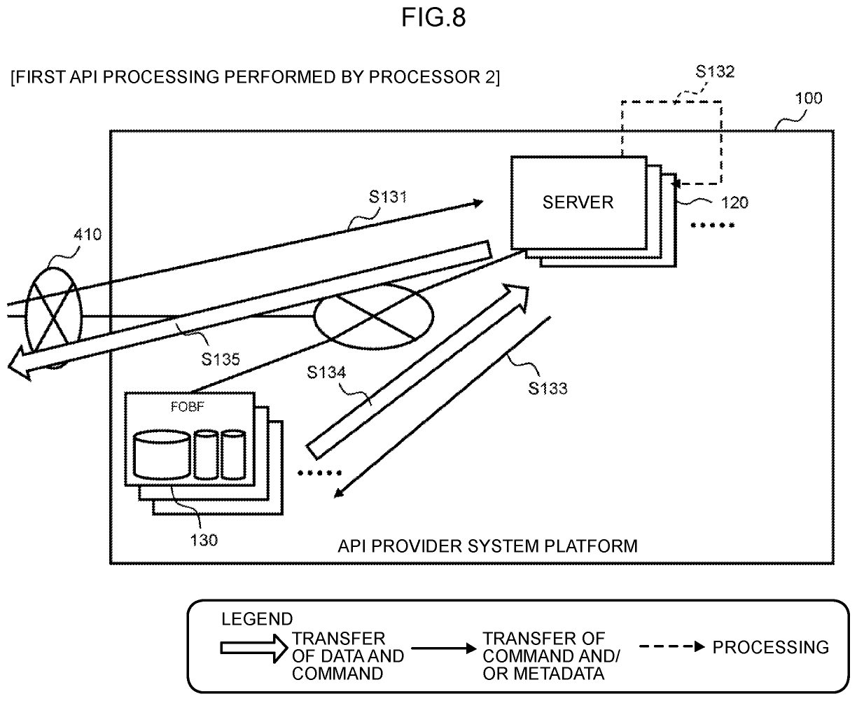

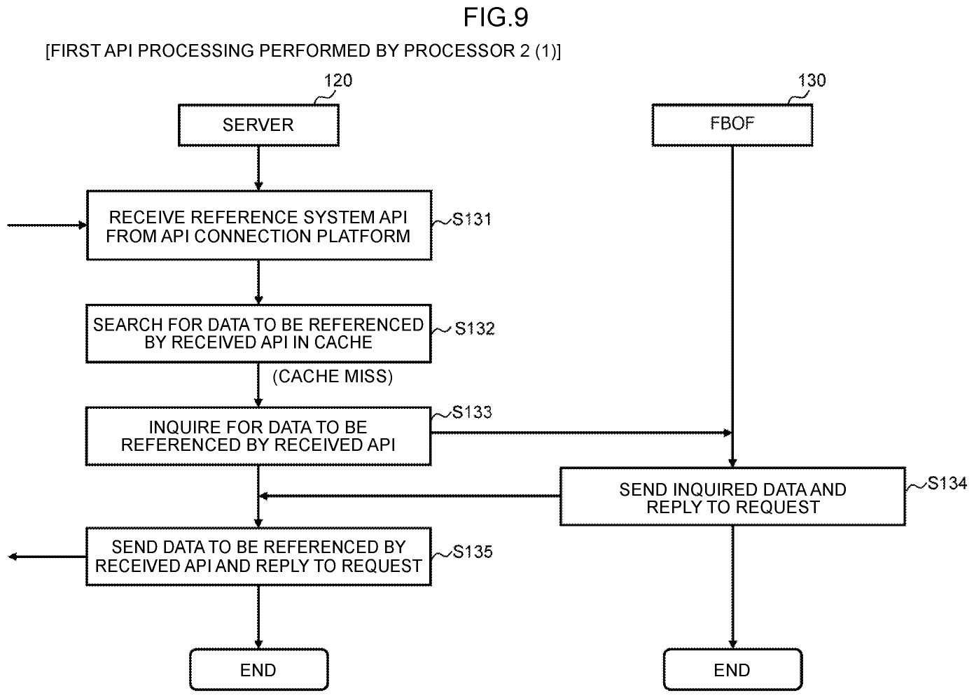

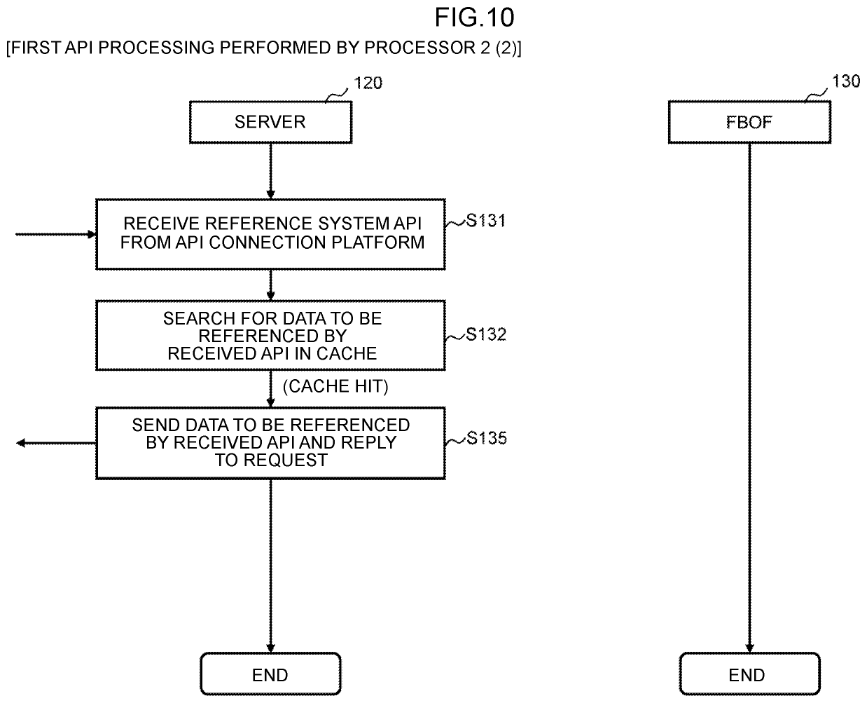

FIG. 8 is a block diagram showing a processing image of the first API processing performed by the processor 2, and FIG. 9 and FIG. 10 are sequence diagrams (part 1, part 2) showing the processing routine thereof.

As shown in the device configuration of the API provider system platform 100 of FIG. 8, the API processing performed by the processor 2 is executed by the server 120 and the FBOF 130. Of the API processing performed by the processor 2, the first API processing is the API processing that is executed when the request received from the API connection platform 200 is for a reference system API and the read direct transfer function is set to invalid.

Note that FIG. 9 shows, of the first API processing performed by the processor 2, the processing routine when the data to be referenced by the reference system API does not exist in the cache of the server 120 (in the case of a cache miss). Meanwhile, FIG. 10 shows, of the first API processing performed by the processor 2, the processing routine when the data to be referenced by the reference system API exists in the cache of the server 120 (in the case of a cache hit).

The processing routine of the first API processing performed by the processor 2 in the case of a cache miss is foremost explained with reference to FIG. 9.

According to FIG. 9, foremost, in response to the API connection platform 200 having sent the request received from the application 300 to the API provider system platform 100 in step S21 of FIG. 3, the server 120 of the API provider system platform 100 receives the request (in this example, for a reference system API) from the API connection platform 200 (step S131).

Next, the server 120 searches whether the data (reference data) which is to be referenced by the reference system API received in step S131 exists in the cache of the server 120 (step S132). As described above, since the reference data does not exist in the cache of the server 120 in the case of FIG. 9, a cache miss will occur in step S132.

Thus, subsequent to step S132, the server 120 makes an inquiry to the FBOF 130 regarding the reference data (step S133).

Next, in response to the inquiry of step S133, the FBOF 130 acquires the reference data from the FBOF 130, and sends the acquired reference data, and the information indicating the reply to the inquiry of step S133, to the server 120 (step S134).

Subsequently, the server 120 sends the reference data received from the FBOF 130 in step S134, and the information indicating the reply to the request of step S131, to the API connection platform 200 as the response to the request (step S135).

The processing routine of the first API processing performed by the processor 2 in the case of a cache hit is now explained with reference to FIG. 10.

In FIG. 10, the processing performed by the server 120 of the API provider system platform 100 of receiving a request (in this example, for a reference system API) from the API connection platform 200 (step S131), and searching whether the data which is to be referenced by the reference system API received in step S131 exists in the cache of the server 120 (step S132) is the same as the processing of FIG. 9.

In the case of FIG. 10, the reference data exists in the cache of the server 120 (cache hit) in step S132. Thus, the server 120 does not need to make an inquiry to the FBOF 130 regarding the reference data, and the processing of steps S133 to S134 of FIG. 9 is no longer required.

Accordingly, subsequent to step S132, the server 120 acquires the reference data from the server 120, and sends the acquired reference data, and the information indicating the reply to the request of step S131, to the API connection platform 200 as the response to the request (step S135).

As a result of the processing shown in FIG. 9 or FIG. 10 being performed in the manner described above, the API provider system platform 100 comprising the device configuration corresponding to the processor 2 can execute the API processing of referencing data according to the request and return the response to the request to the API connection platform 200 when the read direct transfer function has been set to invalid.

### (2-2-2) Second API Processing

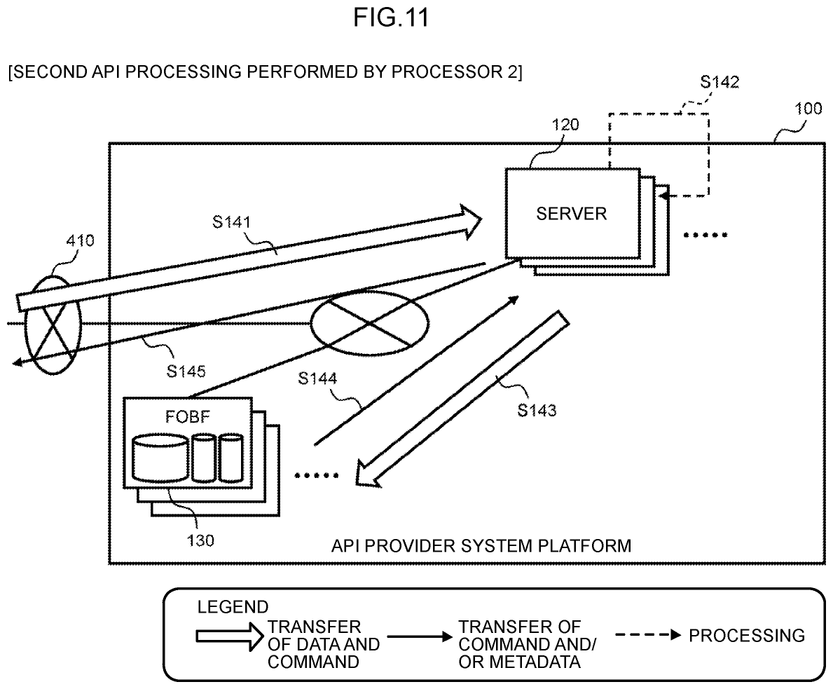

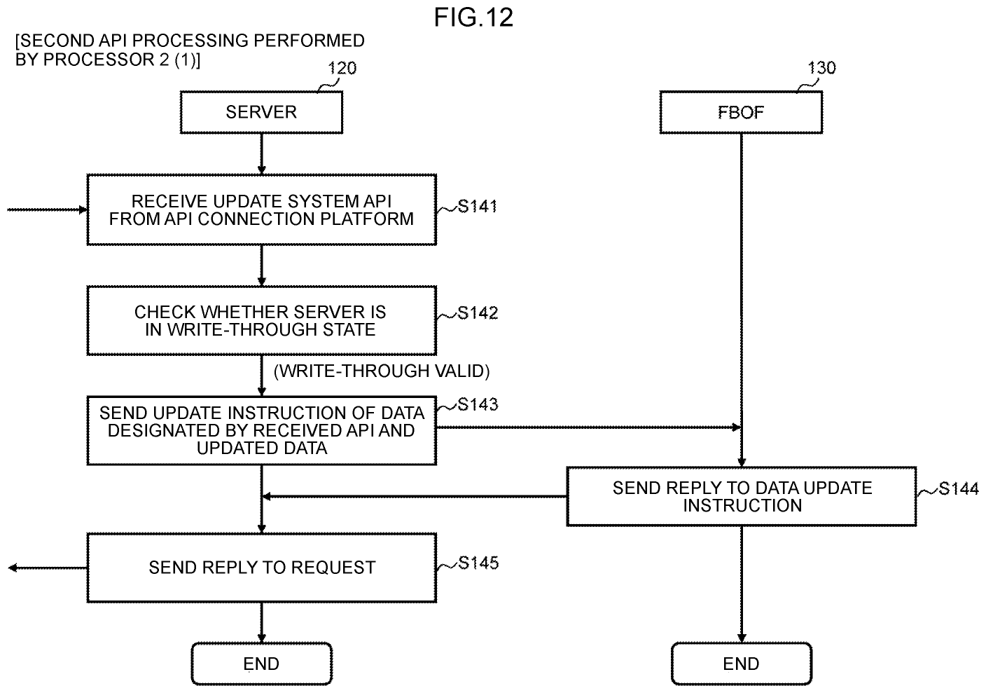

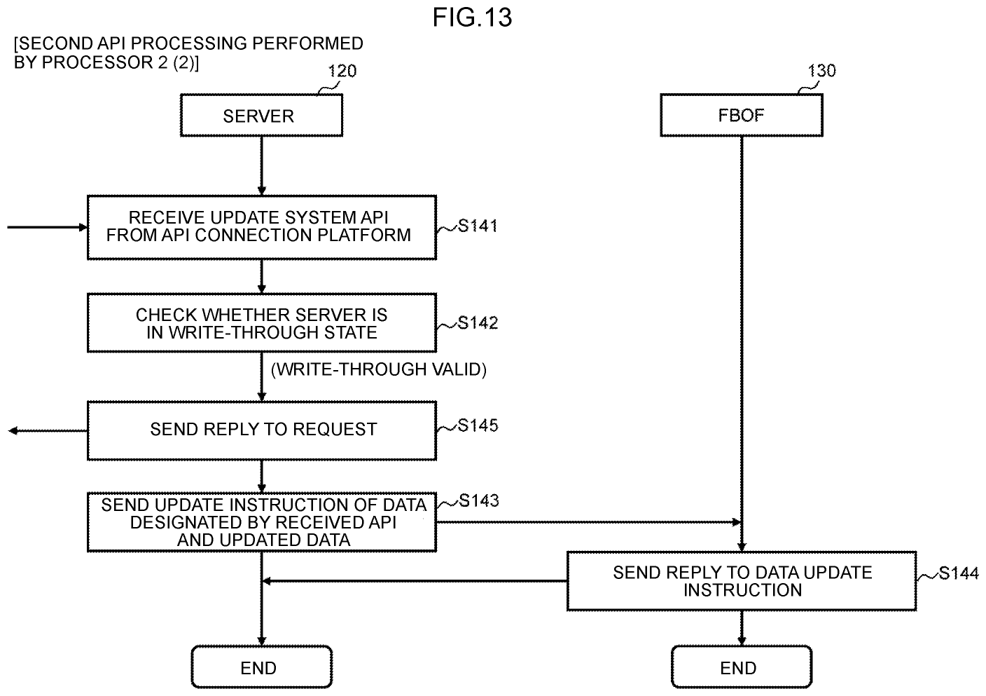

FIG. 11 is a block diagram showing a processing image of the second API processing performed by the processor 2, and FIG. 12 and FIG. 13 are sequence diagrams (part 1, part 2) showing the processing routine thereof.

As shown in the device configuration of the API provider system platform 100 of FIG. 11, the API processing performed by the processor 2 is executed by the server 120 and the FBOF 130. Of the API processing performed by the processor 2, the second API processing is the API processing that is executed when the request received from the API connection platform 200 is for an update system API and the write direct transfer function is set to invalid.

Note that FIG. 12 shows, of the second API processing performed by the processor 2, the processing routine when the write-through is valid; that is, when the write-through function of the server 120 is set to valid. Meanwhile, FIG. 10 shows, of the second API processing performed by the processor 2, the processing routine when the write-through is invalid; that is, when the write-through function of the server 120 is set to invalid. As shown in the write-through coefficient management table 152 of FIG. 37, the write-through coefficient is set to “1” when the write-through function is set to valid, and the write-through coefficient is set to “0” when the write-through function is set to invalid. The same applies below, and redundant explanations will be omitted.

The processing routine of the second API processing performed by the processor 2 when the write-through is valid is now explained with reference to FIG. 12.

According to FIG. 12, foremost, in response to the API connection platform 200 having sent the request received from the application 300 to the API provider system platform 100 in step S21 of FIG. 3, the server 120 of the API provider system platform 100 receives the request (in this example, for an update system API) from the API connection platform 200 (step S141).

Next, the server 120 checks whether the write-through function in the server 120 is set to valid (whether it is in a write-through state) (step S142). As described above, since the write-through function is set to valid in the case of FIG. 12, in step S142 it is confirmed that the server 120 is in a write-through state.

Subsequently, the server 120 updates the data in the cache of the server 120 which was designated by the update system API received in step S141, and sends the update instruction of the data designated by the update system API, and the updated data, to the FBOF 130 (step S143).

Next, in response to the update instruction of step S143, the FBOF 130 updates the data to be updated, which is stored in the FBOF 130, based on the updated data, and sends the information indicating the reply to the data update instruction of step S143 to the server 120 (step S144).

Subsequently, based on the reply to the data update instruction of step S144, the server 120 sends the information indicating the reply to the request of step S141 to the API connection platform 200 as the response to the request (step S145). The processing routine of the second API processing performed by the processor 2 when the write-through is valid is now explained with reference to FIG. 13.

In FIG. 13, the processing performed by the server 120 of the API provider system platform 100 of receiving a request (in this example, for an update system API) from the API connection platform 200 (step S141), and checking whether the write-through function in the server 120 is set to valid (whether it is in a write-through state) (step S142) is the same as the processing of FIG. 12.

In the case of FIG. 13, since the write-through function is set to invalid in step S142, the server 120 can return a response to the request before sending the data update instruction to the FBOF 130. Thus, subsequent to step S142, the server 120 updates the data in the cache of the server 120 which was designated by the update system API, and thereafter sends the information indicating the reply to the request of step S141 to the API connection platform 200 as the response to the request (step S145).

The server 120 thereafter sends the update instruction of the data designated by the update system API, and the updated data, to the FBOF 130 (step S143). Subsequently, in response to the update instruction of step S143, the FBOF 130 updates the data to be updated, which is stored in the FBOF 130, based on the updated data, and sends the information indicating the reply to the data update instruction of step S143 to the server 120 (step S144).

As a result of the processing shown in FIG. 12 or FIG. 13 being performed in the manner described above, the API provider system platform 100 comprising the device configuration corresponding to the processor 2 can execute the API processing of updating data according to the request and return the response to the request to the API connection platform 200 when the write direct transfer function has been set to invalid.

### (2-3) API Processing Performed by the Processor 3

The API processing performed by the processor 3 shown in step S34 of FIG. 3 is now explained in detail.

### (2-3-1) First API Processing

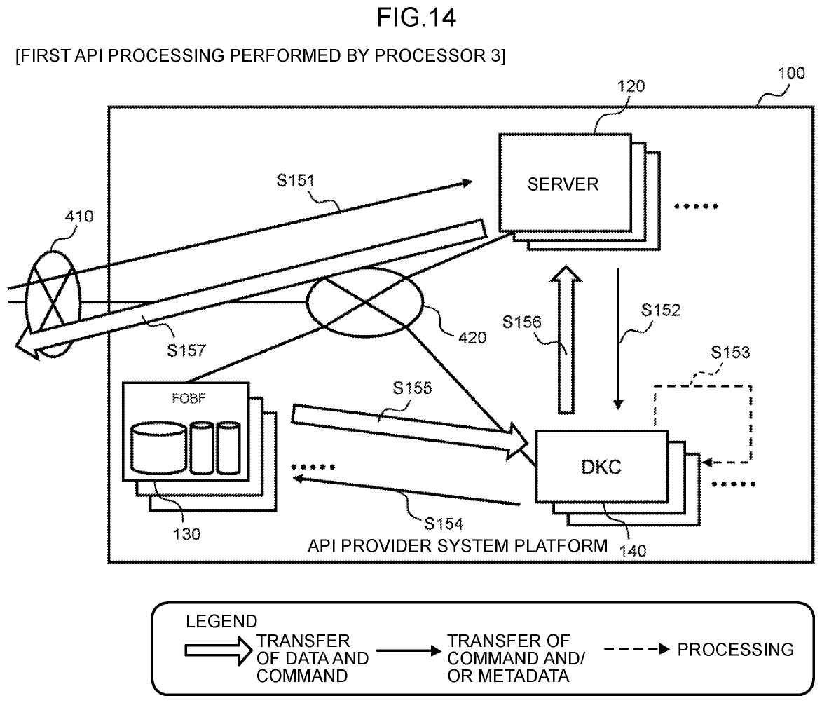

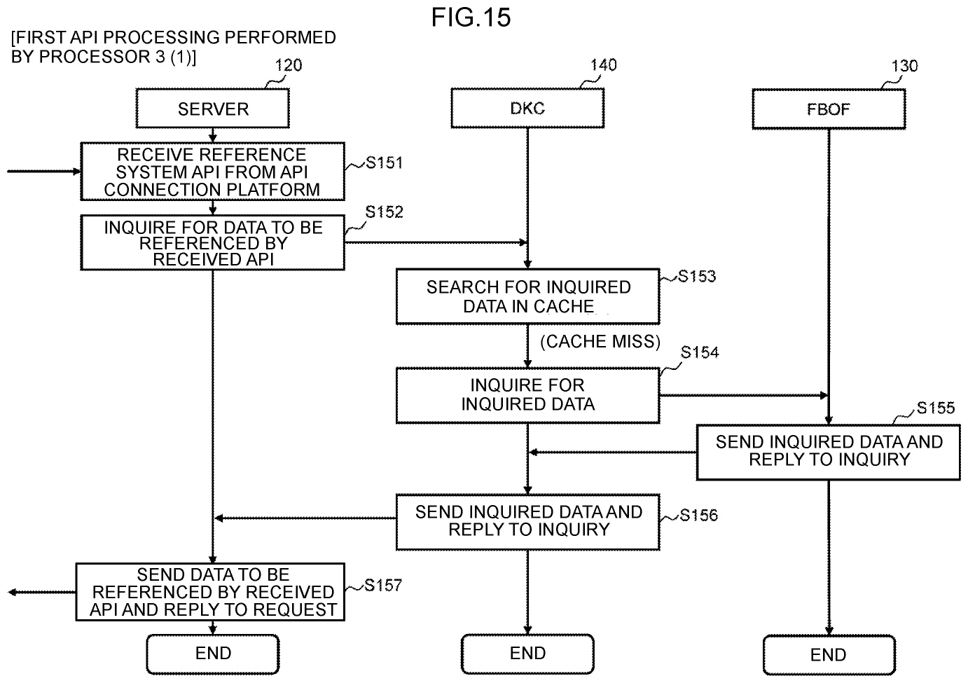

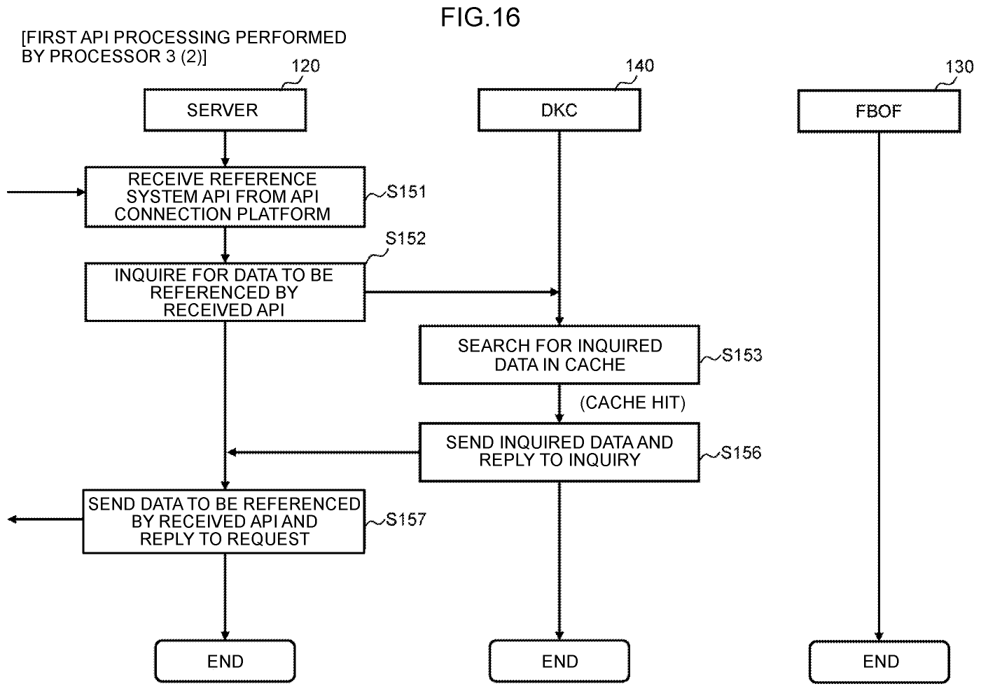

FIG. 14 is a block diagram showing a processing image of the first API processing performed by the processor 3, and FIG. 15 and FIG. 16 are sequence diagrams (part 1, part 2) showing the processing routine thereof.

As shown in the device configuration of the API provider system platform 100 of FIG. 14, the API processing performed by the processor 3 is executed by the server 120, the FBOF 130 and the DKC 140. Of the API processing performed by the processor 3, the first API processing is the API processing that is executed when the request received from the API connection platform 200 is for a reference system API and the read direct transfer function is set to invalid.

Note that FIG. 15 shows, of the first API processing performed by the processor 3, the processing routine when the data to be referenced by the reference system API does not exist in the cache of the DKC 140 (in the case of a cache miss). Meanwhile, FIG. 10 shows, of the first API processing performed by the processor 3, the processing routine when the data to be referenced by the reference system API exists in the cache of the DKC 140 (in the case of a cache hit).

The processing routine of the first API processing performed by the processor 3 in the case of a cache miss is foremost explained with reference to FIG. 15.

According to FIG. 15, foremost, in response to the API connection platform 200 having sent the request received from the application 300 to the API provider system platform 100 in step S21 of FIG. 3, the server 120 of the API provider system platform 100 receives the request (in this example, for a reference system API) from the API connection platform 200 (step S151).

Next, the server 120 makes an inquiry to the DKC 140 regarding the data (reference data) to be referenced by the reference system API received in step S151 (step S152).

In response to the inquiry of step S152, the DKC 140 searches whether the reference data exists in the cache of the DKC 140 (step S153). As described above, since the reference data does not exist in the cache of the DKC 140 in the case of FIG. 15, a cache miss will occur in step S153.

Thus, subsequent to step S153, the DKC 140 makes an inquiry to the FBOF 130 regarding the reference data for which an inquiry was received from the server 120 (step S154).

Next, in response to the inquiry of step S154, the FBOF 130 acquires the reference data from the FBOF 130, and sends the acquired reference data, and the information indicating the reply to the inquiry of step S154, to the DKC 140 (step S155).

Next, the DKC 140 sends the reference data received from the FBOF 130 in step S155, and the information indicating the reply to the inquiry of step S152, to the server 120 (step S156).

Subsequently, the server 120 sends the reference data received from the DKC 140 in step S156, and the information indicating the reply to the request of step S151, to the API connection platform 200 as the response to the request (step S157).

The processing routine of the first API processing performed by the processor 3 in the case of a cache hit is now explained with reference to FIG. 16.

In FIG. 16, the processing performed by the server 120 of the API provider system platform 100 of receiving a request (in this example, for a reference system API) from the API connection platform 200 (step S151), and making an inquiry to the DKC 140 regarding the data to be referenced by the reference system API received in step S151 (step S152), and the processing performed by the DKC 140 of searching whether the reference data exists in the cache of the DKC 140 (step S153) are the same as the processing of FIG. 15.

In the case of FIG. 16, the reference data exists in the cache of the DKC 140 (cache hit) in step S153. Thus, the DKC 140 does not need to make an inquiry to the FBOF 130 regarding the reference data, and the processing of steps S154 to S155 of FIG. 15 is no longer required.

Accordingly, subsequent to step S153, the DKC 140 acquires the reference data from the DKC 140, and sends the acquired reference data, and the information indicating the reply to the request of step S152, to the server 120 (step S156). Subsequently, the server 120 sends the reference data received from the DKC 140 in step S156, and the information indicating the reply to the request of step S151, to the API connection platform 200 as the response to the request (step S157).

As a result of the processing shown in FIG. 15 or FIG. 16 being performed in the manner described above, the API provider system platform 100 comprising the device configuration corresponding to the processor 3 can execute the API processing of referencing data according to the request and return the response to the request to the API connection platform 200 when the read direct transfer function has been set to invalid.

### (2-3-2) Second API Processing

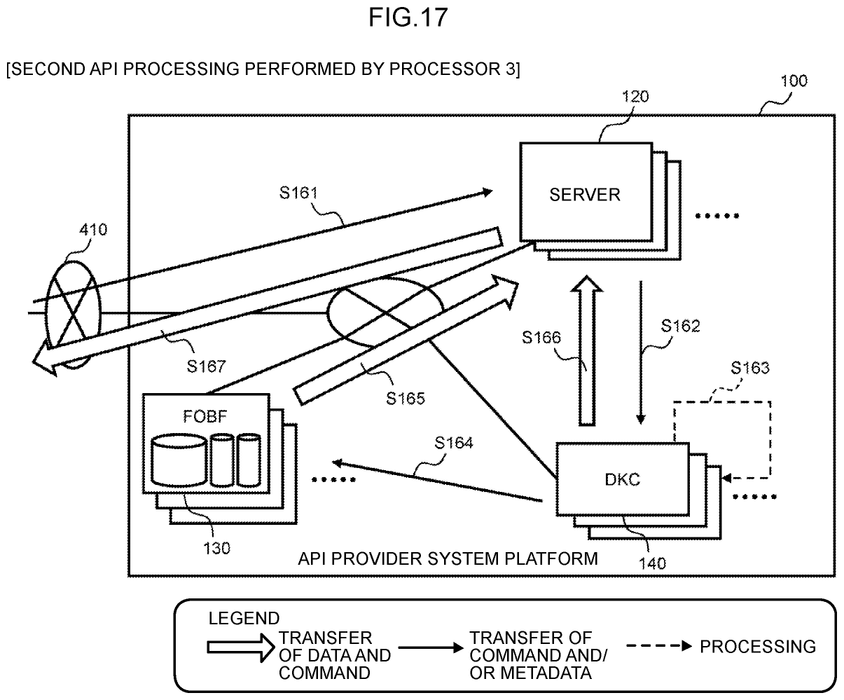

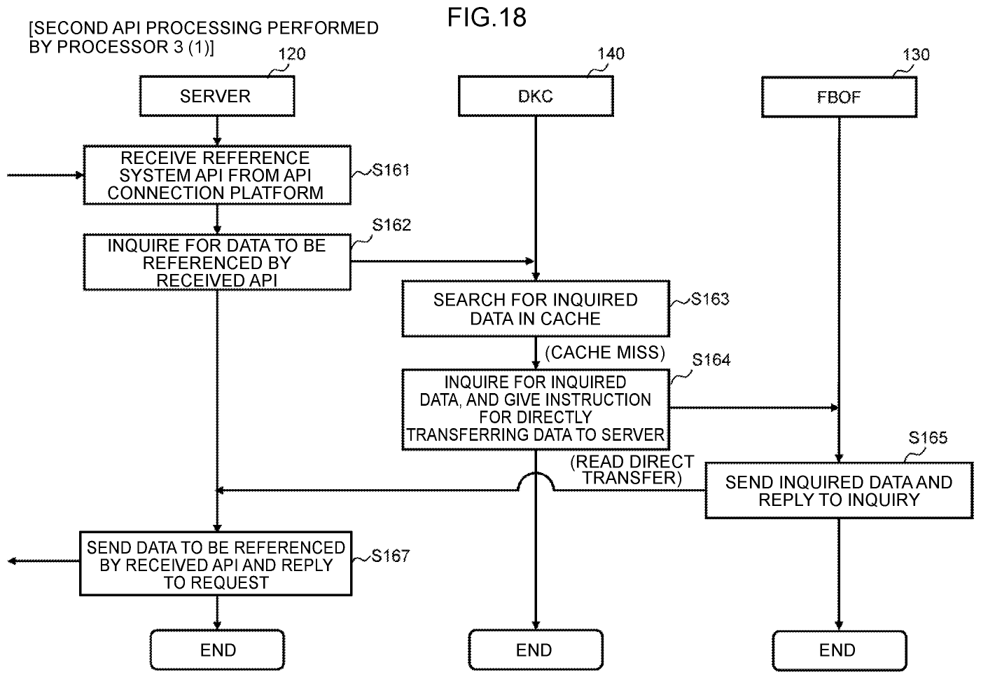

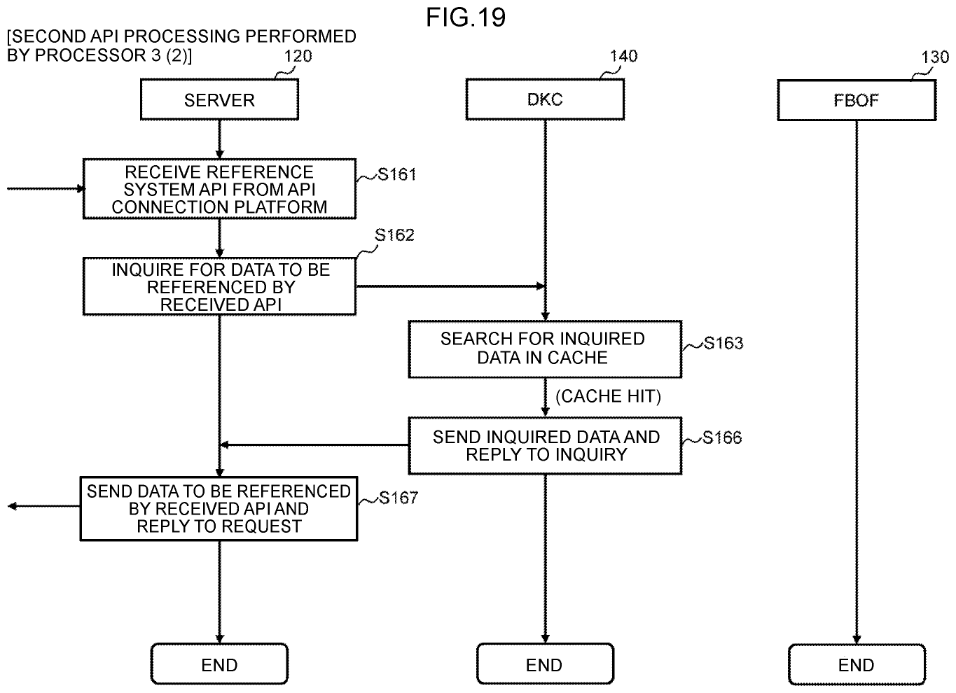

FIG. 17 is a block diagram showing a processing image of the second API processing performed by the processor 3, and FIG. 18 and FIG. 19 are sequence diagrams (part 1, part 2) showing the processing routine thereof.

As shown in the device configuration of the API provider system platform 100 of FIG. 17, the API processing performed by the processor 3 is executed by the server 120, the FBOF 130 and the DKC 140. Of the API processing performed by the processor 3, the second API processing is the API processing that is executed when the request received from the API connection platform 200 is for a reference system API and the read direct transfer function is set to valid.

Note that FIG. 18 shows, of the second API processing performed by the processor 3, the processing routine when the data to be referenced by the reference system API does not exist in the cache of the DKC 140 (in the case of a cache miss). Meanwhile, FIG. 19 shows, of the second API processing performed by the processor 3, the processing routine when the data to be referenced by the reference system API exists in the cache of the DKC 140 (in the case of a cache hit).

The processing routine of the second API processing performed by the processor 3 in the case of a cache miss is foremost explained with reference to FIG. 18.

According to FIG. 18, foremost, in response to the API connection platform 200 having sent the request received from the application 300 to the API provider system platform 100 in step S21 of FIG. 3, the server 120 of the API provider system platform 100 receives the request (in this example, for a reference system API) from the API connection platform 200 (step S161).

Next, the server 120 makes an inquiry to the DKC 140 regarding the data (reference data) to be referenced by the reference system API received in step S161 (step S162).

In response to the inquiry of step S162, the DKC 140 searches whether the reference data exists in the cache of the DKC 140 (step S163). As described above, since the reference data does not exist in the cache of the DKC 140 in the case of FIG. 18, a cache miss will occur in step S163.

Thus, subsequent to step S163, the DKC 140 makes an inquiry to the FBOF 130 regarding the reference data for which an inquiry was received from the server 120 (step S164). In step S164, since the read direct transfer function is set to valid, the DKC 140 instructs the FBOF 130 to directly transfer, to the server 120, the reply to the inquiry of the reference data.

Next, in response to the inquiry of step S164, the FBOF 130 acquires the reference data from the FBOF 130, and directly sends the acquired reference data, and the information indicating the reply to the inquiry of step S162, to the server 120 without going through the DKC 140 (step S165).

Subsequently, the server 120 sends the reference data received from the FBOF 130 in step S165, and the information indicating the reply to the request of step S151, to the API connection platform 200 as the response to the request (step S167).

Note that, when comparing the processing of FIG. 18 described above with the processing of FIG. 15 in which the read direct transfer function was set to invalid, while the two steps of steps S155 and S156 were required in FIG. 15 upon sending the reference data from the FBOF 130 to the server 120, it is obvious that, in FIG. 18, only the one step of step S165 is required based on the read direct transfer. Consequently, with the processing of FIG. 18, the server 120 can send the response to the request faster in comparison to the processing of FIG. 15.

The processing routine of the second API processing performed by the processor 3 in the case of a cache hit shown in FIG. 19 is now confirmed. In the case of FIG. 19, while the read direct transfer function is set to valid in the same manner as the case of FIG. 18, since the reference data encounters a cache hit in the DKC 140, data access to the FBOF 130 is not performed, and the direct transfer of data based on the read direct transfer function is not performed. Accordingly, since the processing routine shown in FIG. 19 is not affected by the setting of the read direct transfer function and is the same as the processing routine when the read direct transfer function is set to invalid as shown in FIG. 16, the explanation thereof is omitted.

As a result of the processing shown in FIG. 18 or FIG. 19 being performed in the manner described above, the API provider system platform 100 comprising the device configuration corresponding to the processor 3 can execute the API processing of referencing data according to the request and return the response to the request to the API connection platform 200 when the read direct transfer function has been set to valid.

### (2-3-3) Third API Processing

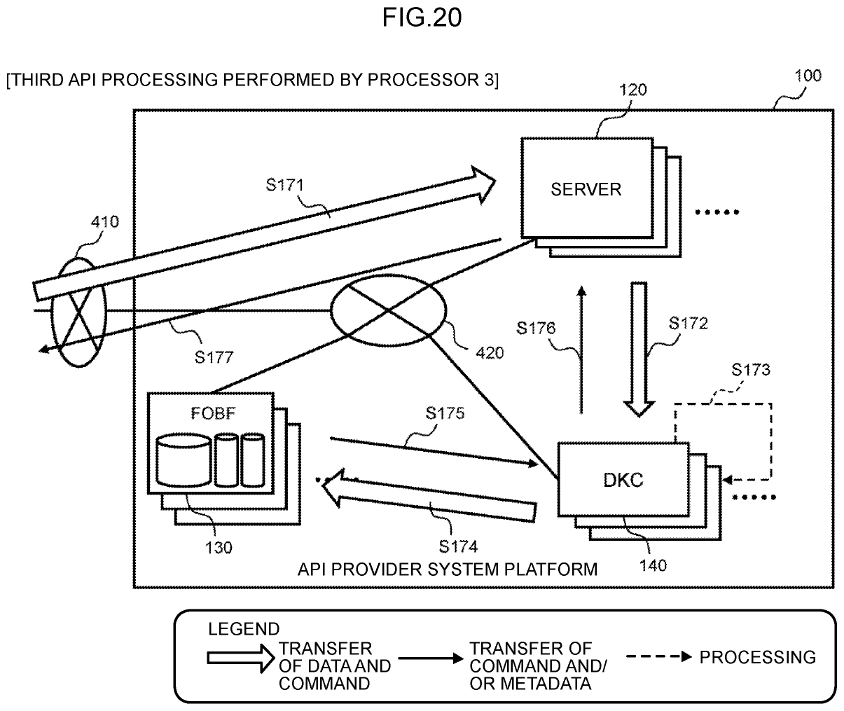

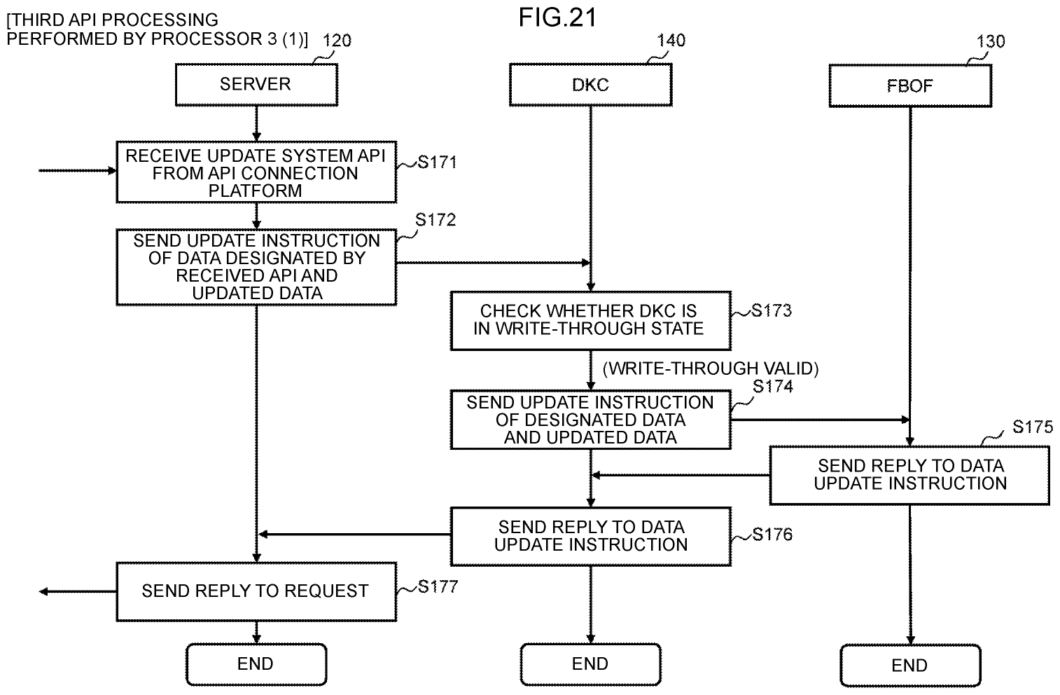

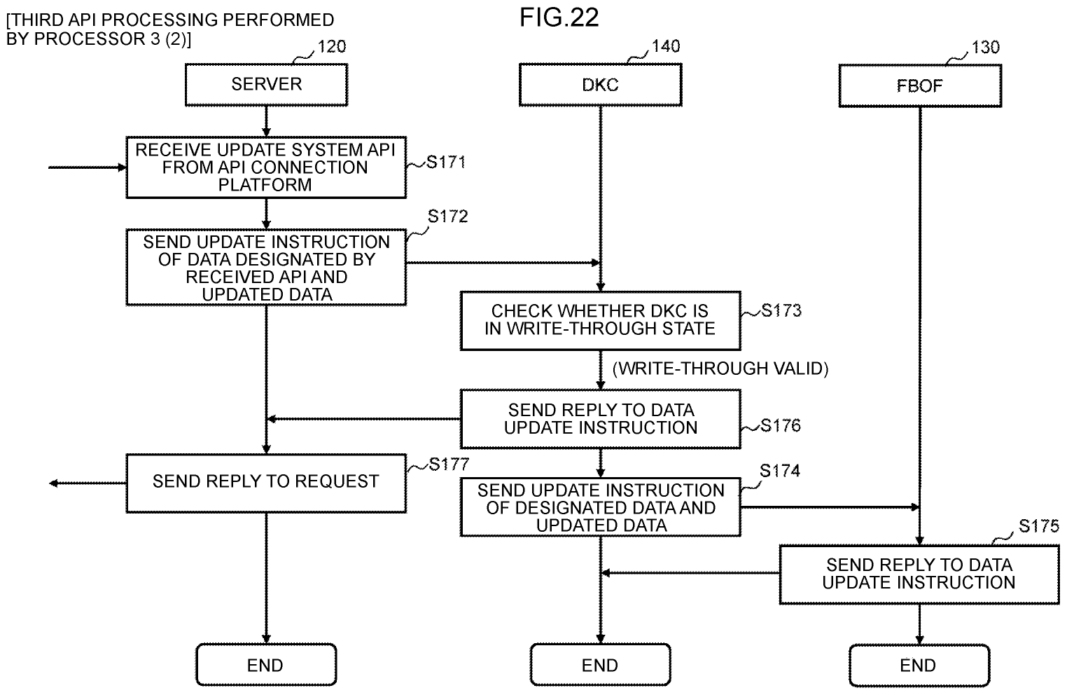

FIG. 20 is a block diagram showing a processing image of the third API processing performed by the processor 3, and FIG. 21 and FIG. 22 are sequence diagrams (part 1, part 2) showing the processing routine thereof.

As shown in the device configuration of the API provider system platform 100 of FIG. 20, the API processing performed by the processor 3 is executed by the server 120, the FBOF 130 and the DKC 140. Of the API processing performed by the processor 3, the third API processing is the API processing that is executed when the request received from the API connection platform 200 is for an update system API and the write direct transfer function is set to invalid.

Note that FIG. 21 shows, of the third API processing performed by the processor 3, the processing routine when the write-through is valid; that is, when the write-through function of the DKC 140 is set to valid. Meanwhile, FIG. 22 shows, of the third API processing performed by the processor 3, the processing routine when the write-through is invalid; that is, when the write-through function of the DKC 140 is set to invalid.

The processing routine of the third API processing performed by the processor 3 when the write-through is valid is now explained with reference to FIG. 21.

According to FIG. 21, foremost, in response to the API connection platform 200 having sent the request received from the application 300 to the API provider system platform 100 in step S21 of FIG. 3, the server 120 of the API provider system platform 100 receives the request (in this example, for an update system API) from the API connection platform 200 (step S171).

Next, the server 120 sends the update instruction of the data designated by the update system API received in step S171, and the updated data, to the DKC 140 (step S172).

Next, the DKC 140 checks whether the write-through function in the DKC 140 is set to valid (whether it is in a write-through state) (step S173). As described above, since the write-through function is set to valid in the case of FIG. 21, in step S173 it is confirmed that the DKC 140 is in a write-through state.

Subsequently, the DKC 140 updates the data in the cache of the DKC 140 which was designated by the update system API, and sends the update instruction of the data designated by the update system API, and the updated data, to the FBOF 130 (step S174).

Next, in response to the update instruction of step S174, the FBOF 130 updates the data to be updated, which is stored in the FBOF 130, based on the updated data, and sends the information indicating the reply to the data update instruction of step S174 to the DKC 140 (step S175).

Next, in response to the reply of step S175, the DKC 140 sends the information indicating the reply to the data update instruction of step S172 to the server 120 (step S176).

Subsequently, based on the reply to the data update instruction of step S176, the server 120 sends the information indicating the reply to the request of step S171 to the API connection platform 200 as the response to the request (step S145).

The processing routine of the third API processing performed by the processor 3 when the write-through is invalid is now explained with reference to FIG. 22.

In FIG. 22, the processing performed by the server 120 of the API provider system platform 100 of receiving a request (in this example, for an update system API) from the API connection platform 200 (step S171), and sending the update instruction of the data designated by the received update system API, and the updated data, to the DKC 140 (step S172), and the processing performed by the DKC 140 of checking whether the write-through function in the DKC 140 is set to valid (whether it is in a write-through state) (step S173) are the same as the processing of FIG. 21.

In the case of FIG. 22, since the write-through function is set to invalid in step S173, the DKC 140 can return a response to the request before sending the data update instruction to the FBOF 130. Thus, subsequent to step S173, the DKC 140 updates the data in the cache of the DKC 140 which was designated by the update system API, and thereafter sends the information indicating the reply to the request of step S171 to the API connection platform 200 as the response to the request (step S176).

The DKC 140 thereafter sends the update instruction of the data designated by the update system API, and the updated data, to the FBOF 130 (step S174). Subsequently, in response to the update instruction of step S174, the FBOF 130 updates the data to be updated, which is stored in the FBOF 130, based on the updated data, and sends the information indicating the reply to the data update instruction of step S174 to the DKC 140 (step S175).

As a result of the processing shown in FIG. 21 or FIG. 22 being performed in the manner described above, the API provider system platform 100 comprising the device configuration corresponding to the processor 3 can execute the API processing of updating data according to the request and return the response to the request to the API connection platform 200 when the write direct transfer function has been set to invalid.

### (2-3-4) Fourth API Processing

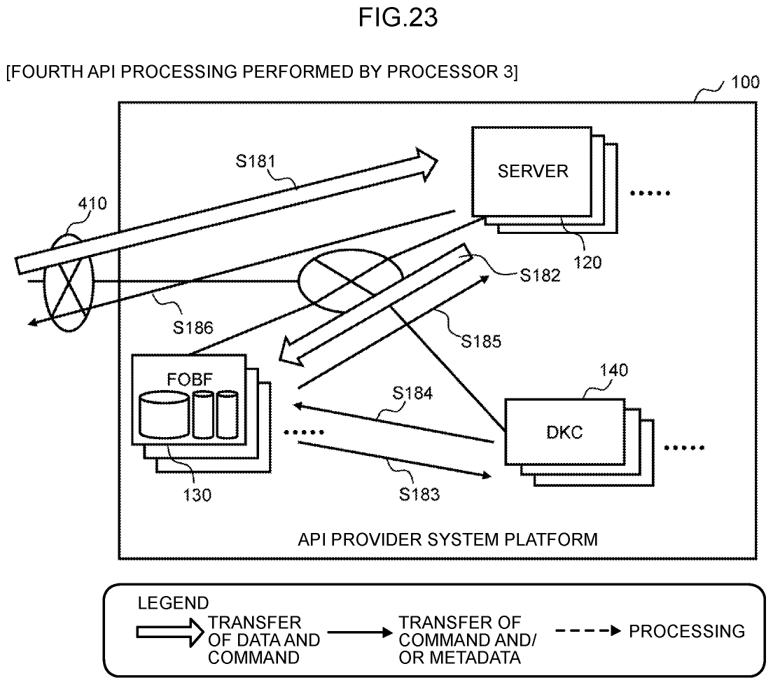

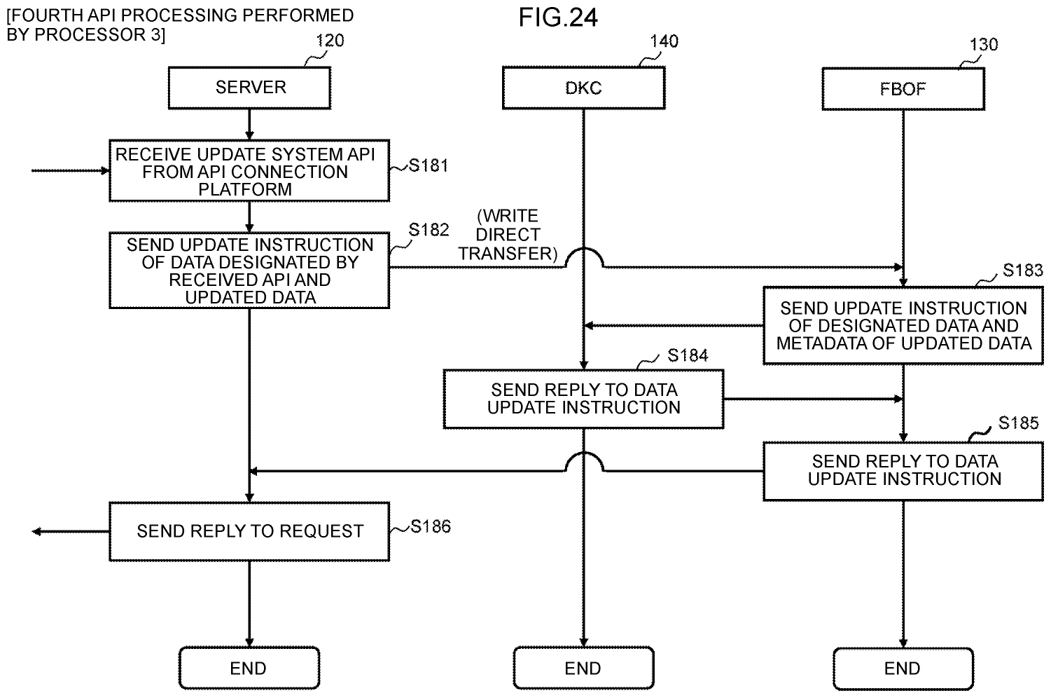

FIG. 23 is a block diagram showing a processing image of the fourth API processing performed by the processor 3, and FIG. 24 is a sequence diagram showing the processing routine thereof.

As shown in the device configuration of the API provider system platform 100 of FIG. 23, the API processing performed by the processor 3 is executed by the server 120, the FBOF 130 and the DKC 140. Of the API processing performed by the processor 3, the fourth API processing is the API processing that is executed when the request received from the API connection platform 200 is for an update system API and the write direct transfer function is set to valid.

The processing routine of the fourth API processing performed by the processor 3 is now explained with reference to FIG. 24. Note that, in the fourth API processing, as shown in step S182 of FIG. 24, since the write data is directly transferred from the server 120 to the FBOF 130 without going through the DKC 140, there is no change in the processing routine according to the setting of the write-through function in the DKC 140.

According to FIG. 24, foremost, in response to the API connection platform 200 having sent the request received from the application 300 to the API provider system platform 100 in step S21 of FIG. 3, the server 120 of the API provider system platform 100 receives the request (in this example, for an update system API) from the API connection platform 200 (step S181).

Next, the server 120 directly sends the update instruction of the data designated by the update system API received in step S181, and the updated data, to the FBOF 130 without going through the DKC 140 based on the write direct transfer function (step S182).

Next, in response to the update instruction of step S182, the FBOF 130 updates the data to be updated, which is stored in the FBOF 130, based on the updated data, and sends the update instruction of the data designated by the update system API, and the metadata of the updated data, to the DKC 140 (step S183).

Next, in response to the update instruction of step S183, the DKC 140 updates the data to be updated in the cache of the DKC 140, based on the updated data, and sends the information indicating the reply to the update instruction of step S183 to the FBOF 130 (step S184).

Next, the FBOF 130 directly sends the information indicating the reply to the data update instruction of step S182 to the server 120 without going through the DKC 140 based on the write direct transfer function (step S185).

Subsequently, based on the reply to the data update instruction of step S185, the server 120 sends the information indicating the reply to the request of step S181 to the API connection platform 200 as the response to the request (step S186).

As a result of the processing shown in FIG. 24 being performed in the manner described above, the API provider system platform 100 comprising the device configuration corresponding to the processor 3 can execute the API processing of updating data according to the request and return the response to the request to the API connection platform 200 when the write direct transfer function has been set to valid.

### (2-4) API Usage Fee Determination Processing

The API usage fee determination processing shown in step S26 of FIG. 3 is now explained in detail. As described above in step S26 of FIG. 3, the API usage fee determination processing is processing that is executed by the API usage fee calculation unit 220 of the server 210 in the API connection platform 200, and the billing amount (API usage fee) to the application 300 that used the API is determined based on the request for the API from the application 300 and the history of the response thereof, and the prescribed information related to data processing resources in the API provider system platform 100 and the API connection platform 200.

FIG. 25 is a flowchart showing a processing routine example of the API usage fee determination processing. Note that the API usage fee determined based on the API usage fee determination processing shown in FIG. 25 is calculated by using the API usage fee calculation formula configured from Formula 1 to Formula 11 described later in detail. Thus, in the following explanation, the processing routine of the API usage fee determination processing shown in FIG. 25 will be explained by specifying the corresponding part of the API usage fee calculation formula, and the individual mathematical expressions of the API usage fee calculation formula will be explained in detail thereafter.

In each of the processing of steps S191 to S195 of FIG. 25, the API usage fee calculation unit 220 acquires, as appropriate, the required information from the prescribed information related to data processing resources in the API connection platform 200 acquired in step S25 of FIG. 3, the prescribed information related to data processing resources in the API provider system platform 100 acquired and received in step S35, and the respective management tables (refer to FIG. 27 to FIG. 53) of the API provider system platform 100 and the API connection platform 200.

According to FIG. 25, foremost, the API usage fee calculation unit 220 acquires information related to the utilization history of the server 120, the DKC 140, and the FBOF 130 at a certain time (step S191). The information acquired in step S191 corresponds to the denominator and the numerator of the fractional terms of Formula 4 to Formula 6, and Formula 9 to Formula 11.

Note that the term “certain time” in step S191 corresponds to the timing at the end of the calculation period of the API usage fee. Specifically, for example, the “certain time” may be determined in advance such as a predetermined time of each day, or the timing requested by the API user may also be used as the “certain time”. In step S192 onward, this “certain time” is indicated as “that time”.

Next, the API usage fee calculation unit 220 calculates the reference system API and the data processing resource amount of the update system API and the value thereof at that time in the server 120, the DKC 140, and the FBOF 130, respectively (step S192). The values calculated in step S192 correspond to each “data processing resource amount and value thereof” in Formula 4 to Formula 6, and Formula 9 to Formula 11.

Next, with regard to a certain application 300 at that time, the API usage fee calculation unit 220 calculates the number of requests of the reference system API and the update system API, the total amount of data referenced or updated by the API, and the average latency based on the application 300 (step S193). The “number of requests of reference system API and update system API” calculated in step S193 corresponds to the “reference system API call count” in Formula 2 and the “update system API call count” in Formula 7, and the “total amount of data referenced or updated by API” corresponds to the “amount of data referenced by reference system API” in Formula 2 and the “amount of data updated by update system API” in Formula 7.

Note that the “certain application 300” in step S193 is the application 300 to which the API usage fee is to be billed. In step S194 onward, this “certain application 300” is indicated as “the application 300”.

Next, the API usage fee calculation unit 220 calculates the reference system API usage fee and the update system API usage fee to the application 300 at that time (step S194). The calculation of step S194 corresponds to Formula 2 and Formula 7.

Subsequently, the API usage fee calculation unit 220 uses the reference system API usage fee and the update system API usage fee calculated in step S194 to calculate the API usage fee to be billed to the application 300 at that time (step S195). The calculation of step S195 corresponds to Formula 1.

As described above, the API usage fee can be calculated by using the API usage fee calculation formula configured from Formula 1 to Formula 11 below. Note that the following API usage fee calculation formula is based on the premise of sufficiently ensuring the network bandwidth of the networks 410, 420, 430.

Formula 1 to Formula 11 of the API usage fee calculation formula are now explained in detail.

$$\begin{matrix}[ Math 1 ] & \\ API usage fee = ( reference system API usage fee + update system API usage fee ) \times arbitrary constant 1 & ( Formula 1 )\end{matrix}$$

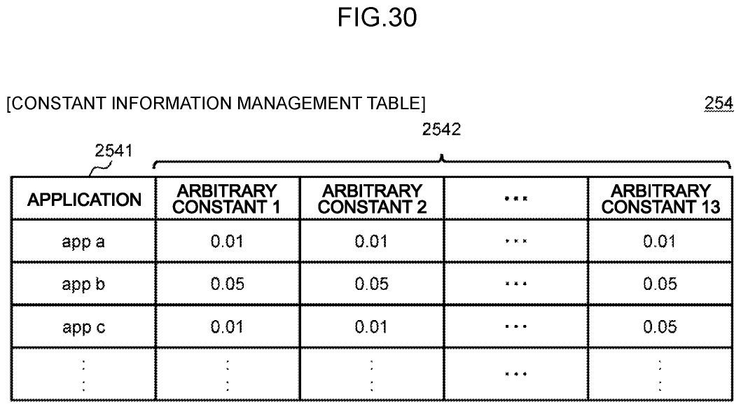

The calculation formula of the “reference system API usage fee” in Formula 1 above is shown in Formula 2, and the calculation formula of the “update system API usage fee” in Formula 1 above is shown in Formula 7. Moreover, with regard to the “arbitrary constant 1”, the constant value is stored in the arbitrary constant 2542 of the constant information management table 254 shown in FIG. 30. With regard to the other constants “arbitrary constant 2” to “arbitrary constant 11” used in Formula 2 to Formula 11 described later, the constant value is similarly stored in the constant information management table 254 shown in FIG. 30, and the redundant explanation thereof is omitted. Since the value of the arbitrary constant is set for each application 300 in the constant information management table 254 of FIG. 30, the API usage fee calculation unit 220 can calculate the API usage fee by multiplying a coefficient that differs for each application 300 based on Formula 1.

$$\begin{matrix}[ Math 2 ] & \\ Reference system API usage fee = reference system API call count \times amount of data referenced by reference system API \times data processing resource amount of reference system API and value thereof \times ( target latency of reference system API / average of actual latency of reference system API within unit time ) \times arbitrary constant 2 & ( Formula 2 )\end{matrix}$$

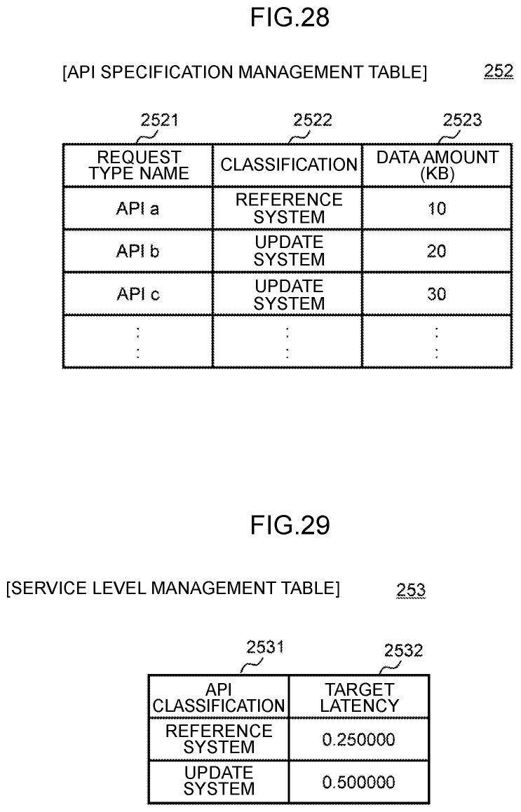

The “reference system API call count” in Formula 2 above means the number of requests of the reference system API from the application 300 that is subject to the calculation of the usage fee within the usage fee calculation period, and can be acquired from the API request history management table 251 shown in FIG. 27. Moreover, the “amount of data referenced by reference system API” can be acquired from the data amount 2523 of the API specification management table 252 shown in FIG. 28. Moreover, the calculation formula of the “data processing resource amount of reference system API and value thereof” is shown in Formula 3. Moreover, the “target latency of reference system API” can be acquired from the target latency 2532 of the service level management table 253 shown in FIG. 29. Moreover, the “average of actual latency of reference system API within unit time” can be calculated from the API request history management table 251 shown in FIG. 27.

$$\begin{matrix}[ Math 3 ] & \\ Data processing resource amount of reference system APU and value thereof = data processing resource amount of server and value thereof + data processing resource amount of DKC and value thereof + data processing resource amount of FBOF and value thereof & ( Formula 3 )\end{matrix}$$

The “data processing resource amount of server and value thereof” in Formula 3 above shows the resource amount of the data processing resources and the value thereof in the server 120 in relation to the reference system API, and the calculation formula thereof is shown in Formula 4. Similarly, the calculation formula of the “data processing resource amount of DKC and value thereof” is shown in Formula 5, and the calculation formula of the “data processing resource amount of FBOF and value thereof” is shown in Formula 6.

$$\begin{matrix}[ Math 4 ] & \\ Data processing resource of server and value thereof = ( numerical value calculated from number , utilization rate and price per number of units of CPUs / numerical value calculated from number of utilization days and number of elapsed days from release date of CPUs ) \times arbitrary constant 3 + ( numerical value calculated from number , use rate and price per unit capacity of memories / numerical value calculated from number of utilization days and number of elapsed days from release date of memories ) \times arbitrary constant 4 & ( Formula 4 )\end{matrix}$$

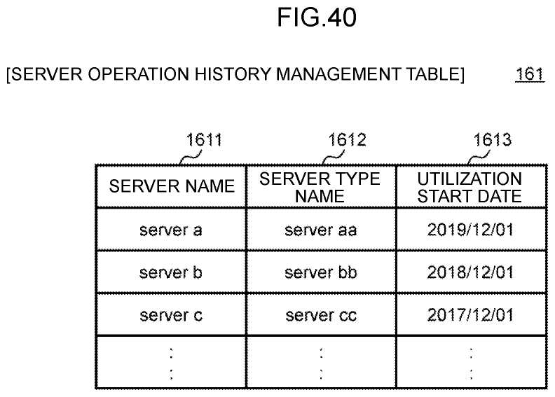

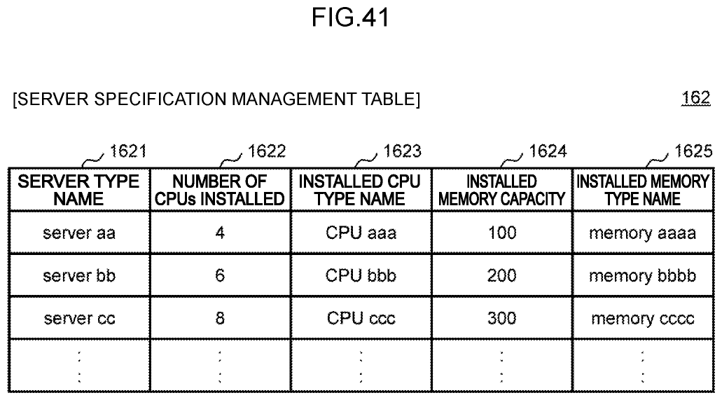

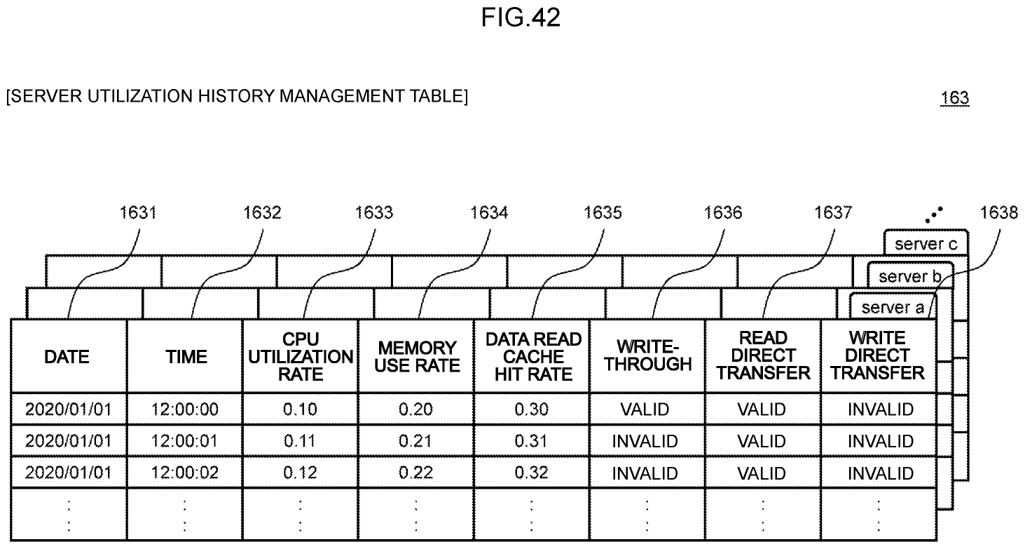

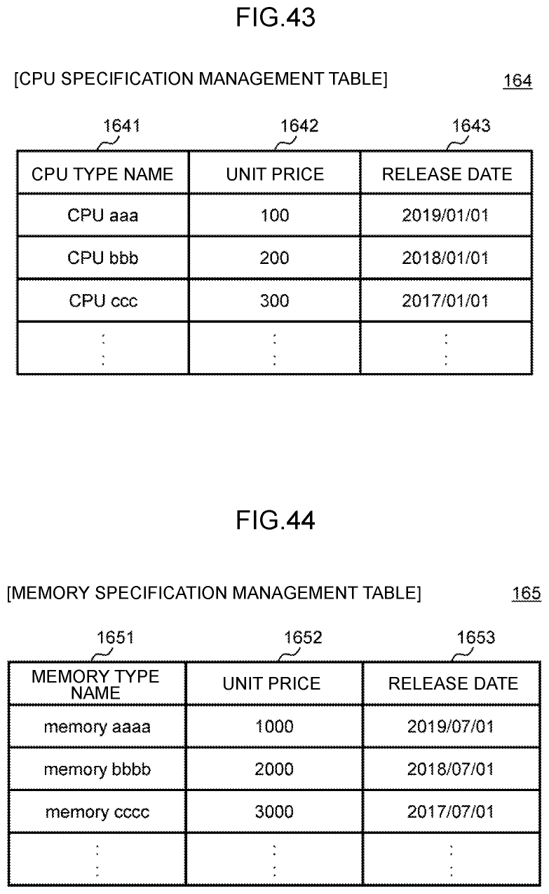

The respective numerical values of the fractional terms in Formula 4 above can be calculated from the specification or utilization history of the server 120 related to the reference system API. Specifically, the configuration information of the CPU and the memory in the server 120 can be acquired from the server specification management table 162 shown in FIG. 41. Furthermore, the foregoing specification of the CPU can be acquired from the CPU specification management table 164 shown in FIG. 43, and the foregoing specification of the memory can be acquired from the memory specification management table 165 shown in FIG. 44. Moreover, the information related to the utilization history by the server 120 can be acquired from the server operation history management table 161 shown in FIG. 40, and the server utilization history management table 163 shown in FIG. 42.

$$\begin{matrix}[ Math 5 ] & \\ Data processing resource amount of DKC and value thereof = ( numerical value calcualted from number , utilization rate and price per number of units of CPUs / numerical value calculated from number of utilization days and number of elapsed days from release date of CPUs ) \times arbitrary constant 5 + ( numerical value calculated from number , use rate and price per unit capacity of memories / numerical value calculated from number of utilization days and number of elapsed days from release date of memories ) \times arbitrary constant 6 & ( Formula 5 )\end{matrix}$$

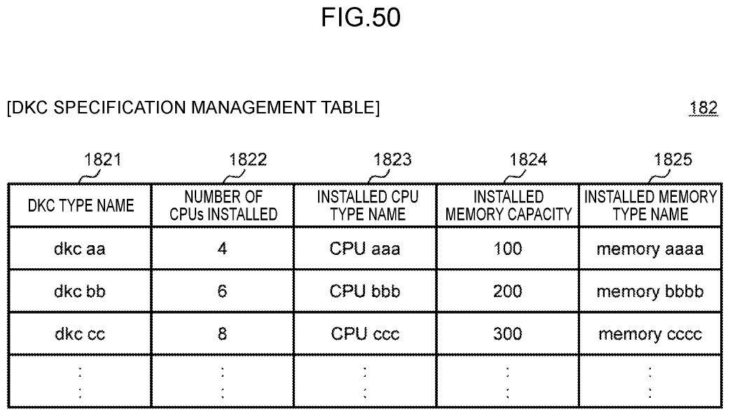

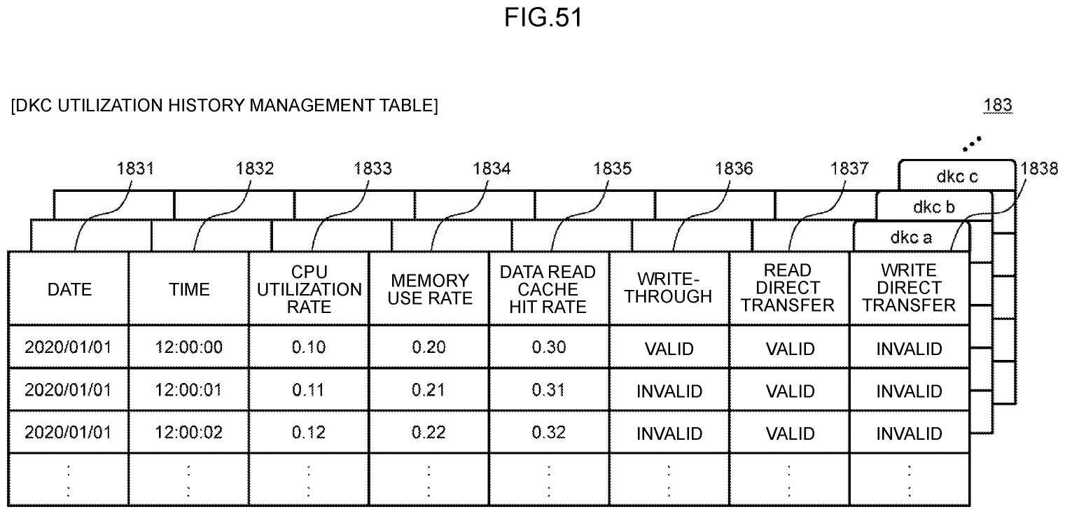

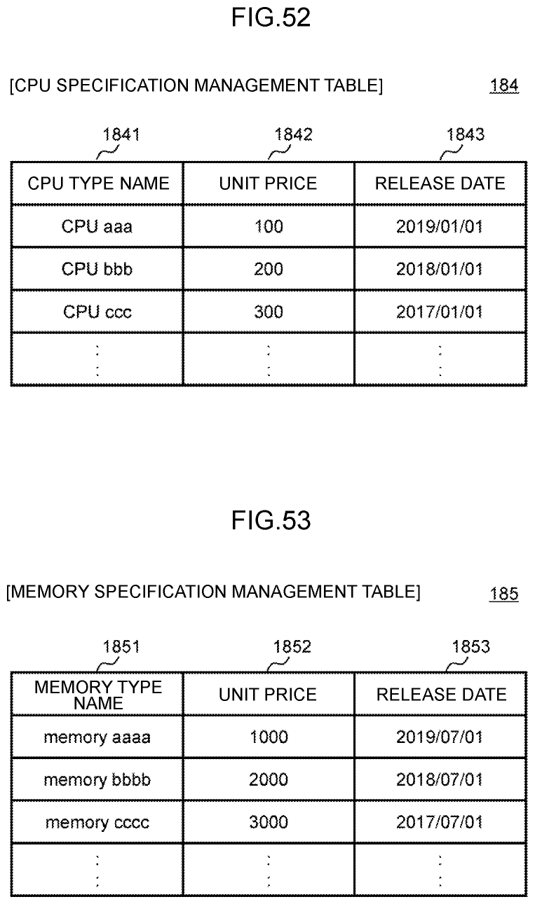

The respective numerical values of the fractional terms in Formula 5 above can be calculated from the specification or utilization history of the DKC 140 related to the reference system API. While the detailed explanation is omitted since it will be the same by substituting the explanation of Formula 4 related to the server 120 with the DKC 140, in Formula 5, the required information can be acquired, as appropriate, from the DKC operation history management table 181 shown in FIG. 49, the DKC specification management table 182 shown in FIG. 50, the DKC utilization history management table 183 shown in FIG. 51, the CPU specification management table 184 shown in FIG. 52, and the memory specification management table 185 shown in FIG. 53.

$$\begin{matrix}[ Math 6 ] & \\ Data processing resource amount of DKC and value thereof = ( numerical value calcualted from number , utilization rate and price per number of units of CPUs / numerical value calculated from number of utilization days and number of elapsed days from release date of CPUs ) \times arbitrary constant 5 + ( numerical value calculated from number , use rate and price per unit capacity of memories / numerical value calculated from number of utilization days and number of elapsed days from release date of memories ) \times arbitrary constant 6 & ( Formula 6 )\end{matrix}$$

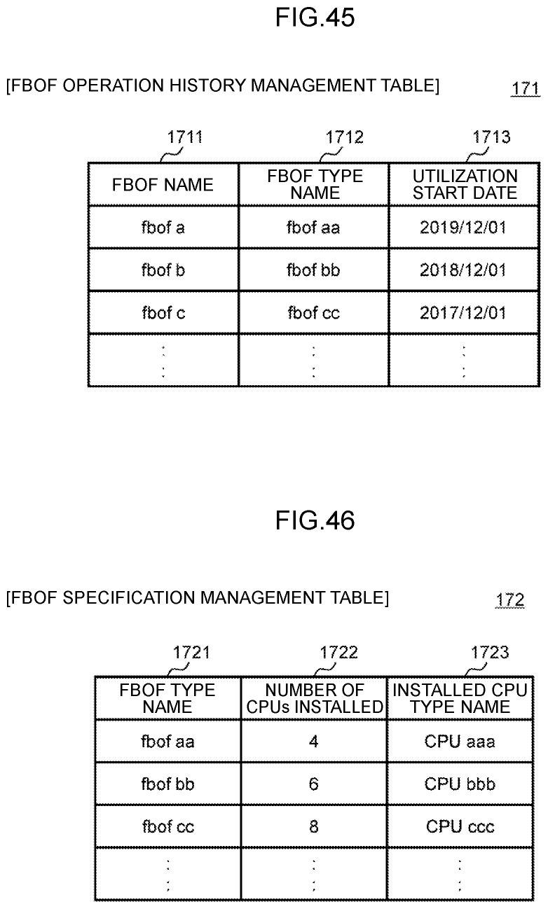

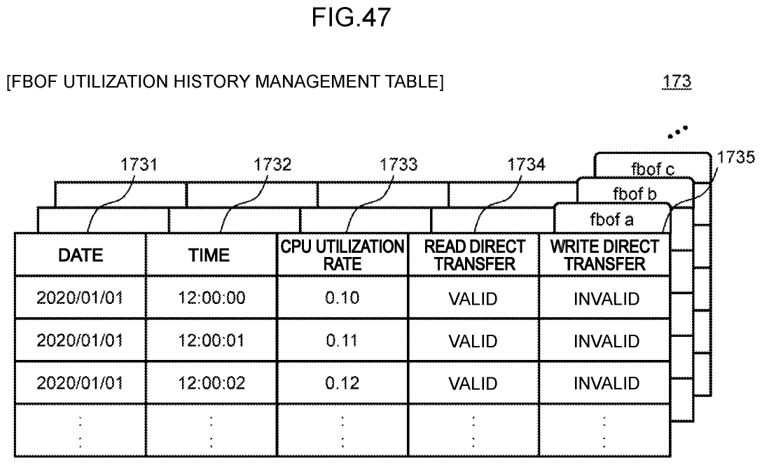

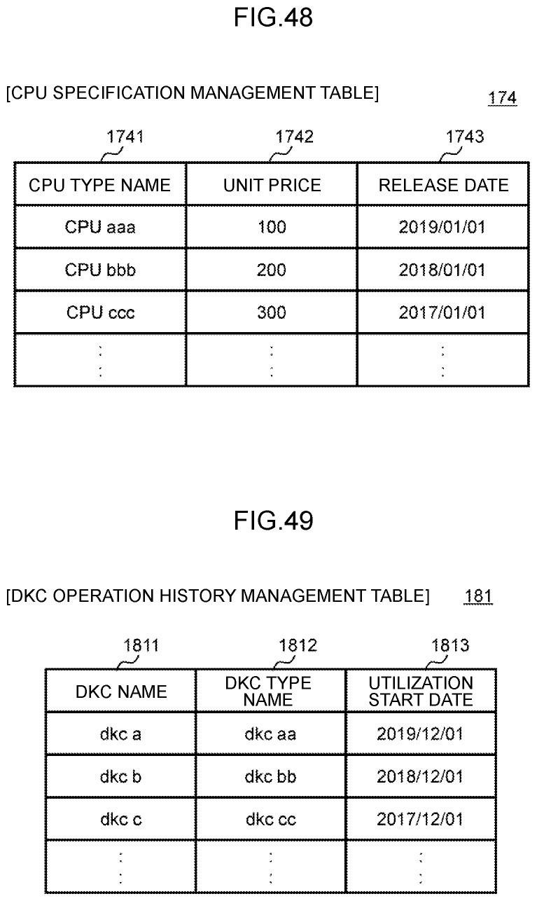

The respective numerical values of the fractional terms in Formula 6 above can be calculated from the specification or utilization history of the FBOF 130 related to the reference system API. While the detailed explanation is omitted since it will be the same by substituting the explanation of Formula 4 related to the server 120 with the FBOF 130, in Formula 6, the required information can be acquired, as appropriate, from the FBOF operation history management table 171 shown in FIG. 45, the FBOF specification management table 172 shown in FIG. 46, the FBOF utilization history management table 173 shown in FIG. 47, and the CPU specification management table 184 shown in FIG. 48. Moreover, the “cache miss rate of server or DKC” regarding the server 120 can be calculated from the data read cache hit rate 1635 of the server utilization history management table 163 shown in FIG. 42, the “cache miss rate of server or DKC” regarding the DKC 140 can be calculated from the data read cache hit rate 1835 of the DKC utilization history management table 183 shown in FIG. 51, and the calculated value of the “1-data read cache rate” becomes the cache miss rate. Moreover, the “read direct transfer coefficient” can be determined based on the read direct transfer 1734 of the FBOF utilization history management table 173 shown in FIG. 47, and the read direct transfer coefficient management table 153 shown in FIG. 38.

$$\begin{matrix}[ Math 7 ] & \\ Update system API call count = update system API call count \times amount of data updated by update system API \times data processing resource amount of update system API and value thereof \times ( target latency of update system API / average of actual latency of update system API within unit time ) \times arbitrary constant 8 & ( Formula 7 )\end{matrix}$$

The “update system API call count” in Formula 7 above means the number of requests of the update system API from the application 300 that is subject to the calculation of the usage fee within the usage fee calculation period, and can be acquired from the API request history management table 251 shown in FIG. 27. Moreover, the “amount of data referenced by update system API” can be acquired from the data amount 2523 of the API specification management table 252 shown in FIG. 28. Moreover, the calculation formula of the “data processing resource amount of update system API and value thereof” is shown in Formula 8. Moreover, the “target latency of update system API” can be acquired from the target latency 2532 of the service level management table 253 shown in FIG. 29. Moreover, the “average of actual latency of update system API within unit time” can be calculated from the API request history management table 251 shown in FIG. 27.

$$\begin{matrix}[ Math 8 ] & \\ Data processing resource amount of update system API and value thereof = data processing resource amount of server and value thereof + ( data processing resource amount of DKC and value thereof + data processing resource amount of FBOF and value thereof ) \times write direct transfer coefficient & ( Formula 8 )\end{matrix}$$

The “data processing resource amount of server and value thereof” in Formula 8 above shows the resource amount of the data processing resources and the value thereof in the server 120 in relation to the update system API, and the calculation formula thereof is shown in Formula 9. Similarly, the calculation formula of the “data processing resource amount of DKC and value thereof” is shown in Formula 10, and the calculation formula of the “data processing resource amount of FBOF and value thereof” is shown in Formula 11. Moreover, the “write direct transfer coefficient” can be determined based on the write direct transfer 1638 of the server utilization history management table 163 shown in FIG. 42, and the write direct transfer coefficient management table 154 shown in FIG. 39.

$$\begin{matrix}[ Math 9 ] & \\ Data processing resource amount of server and value thereof = ( numerical value calculated from number , utilization rate and price per number of units of CPUs / numerical value calculated from number of utilization days and number of elapsed days from release date of CPUs ) \times arbitrary constant 9 + ( numerical value calculated from number , use rate and price per unit capacity of memories / numerical value calculated from number of utilization days and number of elapsed days from release date of memories ) \times arbitrary constant 10 & ( Formula 9 )\end{matrix}$$

The fractional terms in Formula 9 above are indicated in the same manner as the fractional terms of Formula 4 described above. With regard to these fractional terms, while there is a difference in that the numerical values are calculated from the specification or utilization history of the server 120 related to the reference system API in the case of Formula 4, and the numerical values are calculated from the specification or utilization history of the server 120 related to the update system API in the case of Formula 9, since the referenced management tables and the like are common, the detailed explanation thereof is omitted.

$$\begin{matrix}[ Math 10 ] & \\ Data processing resource amount of DKC and value thereof = ( numerical value calculated from number , utilization rate and price per number of units of CPUs / numerical value calculated from number of utilization days and number of elapsed days from release date of CPUs ) \times arbitrary constant 11 + ( numerical value calculated from number , use rate and price per unit capacity of memories / numerical value calculated from number of utilization days and number of elapsed days from release date of memories ) \times arbitrary constant 12 & ( Formula 10 )\end{matrix}$$

The fractional terms in Formula 10 above are indicated in the same manner as the fractional terms of Formula 5 described above. With regard to these fractional terms, while there is a difference in that the numerical values are calculated from the specification or utilization history of the DKC 140 related to the reference system API in the case of Formula 5, and the numerical values are calculated from the specification or utilization history of the DKC 140 related to the update system API in the case of Formula 10, since the referenced management tables and the like are common, the detailed explanation thereof is omitted.

$$\begin{matrix}[ Math 11 ] & \\ Data processing resource amount of FBOF and value thereof = ( numerical value calculated from number , utilization rate and price per number of units of CPUs / numerical value calculated from number of utilization days and number of elapsed days from release date of CPUs ) \times write \text{-} through coefficient of server or DKC \times arbitrary constant 13 & ( Formula 11 )\end{matrix}$$

The fractional terms in Formula 11 above are indicated in the same manner as the fractional terms of Formula 6 described above. With regard to these fractional terms, while there is a difference in that the numerical values are calculated from the specification or utilization history of the FBOF 130 related to the reference system API in the case of Formula 6, and the numerical values are calculated from the specification or utilization history of the FBOF 130 related to the update system API in the case of Formula 11, since the referenced management tables and the like are common, the detailed explanation thereof is omitted. Moreover, the “write-through coefficient of server or DKC” can be determined based on the write-through 1636 of the server utilization history management table 163 shown in FIG. 42, and the write-through coefficient management table 152 shown in FIG. 37.
As described above, as a result of performing calculation using Formula 1 to Formula 11, the API usage fee calculation unit 220 can use the request for the API from the application 300 and the history of the response thereof, and the data processing resource amount and the value thereof in the API billing system 1 (in particular the API provider system platform 100) used pursuant to the provision of the API, as the determinant factors of the API usage fee. Furthermore, in Formula 1, since the API usage fee is calculated by multiplying the coefficient (arbitrary constant 1) which is dependent on the application 300, a different API usage fee can be calculated for each application 300. Consequently, the API usage fee calculation unit 220 can flexibly change the billing amount according to the resource amount and the value of the data processing resources in the service provider's system platform at the time that the API was provided, and according to the API user.
Note that, in the foregoing explanation of the calculation of the API usage fee, while only the server 120 of the API provider system platform 100 was specified and explained as the “server” which is given consideration upon calculating the API usage fee for simplifying the explanation, the API usage fee determination processing of this embodiment is not limited thereto, and the data processing resource amount and the value of the server 210 of the API connection platform 200 can also be included in the basis for calculation of the API usage fee in the same manner as the server 120.

### (2-5) API Usage Fee Display

FIG. 26 is a diagram showing an example of the API usage fee display screen 510. As explained in step S27 of FIG. 3, the API usage fee calculation unit 220 presents the API usage fee calculated based on the API usage fee determination processing, together with the information and the like used in the calculation, to the application 300. The API usage fee display screen 510 shown in FIG. 26 is a presentation example of the API usage fee.

As shown in FIG. 26, the API usage fee display screen 510 is configured by including a period API usage fee 511 which displays the API usage fee in a prescribed calculation period, a statement list 512 which displays a list of statements of the API usage fee displayed on the period API usage fee 511, and a constant list 513 which displays the value of the arbitrary constants used in the API usage fee calculation formula upon calculating the API usage fee displayed on the period API usage fee 511.

The statement list 512, for example, divides the calculation period of the API usage fee into smaller parts (date 5121, time 5122), and displays the reference system API usage fee 5123, the update system API usage fee 5124, and the total 5125 thereof in chronological order. As a result of this kind of statement list 512 being displayed, it is possible to specifically present the breakdown of billing to the API user, and the reliability of the API usage fee can be improved.

The constant list 513 displays the value of the arbitrary constant (in this example, arbitrary constant 1 to arbitrary constant 13) used in Formula 1 to Formula 11 of the foregoing API usage fee calculation formula in the arbitrary constant 5131. The value of this arbitrary constant is defined for each application 300 in the contract of the API providing service, and is the calculation parameter of the API usage fee. As a result of this kind of constant list 513 being displayed, since it is possible to clearly present the basis for calculation of the API usage fee to the API user, the API user can recognize the data processing resource amount and the value thereof required for the processing of each API, and also know the cost expended for retaining the service level (target latency). Consequently, as a result of the transparency of the API provider's service being improved, the API user's reliability in the API provider will improve, and improvement in the customer satisfaction can be expected.

Note that the displayed contents of the API usage fee display screen 510 shown in FIG. 26 are merely an example, and the display method of the API usage fee in the API billing system 1 according to this embodiment is not limited thereto. For example, while the value of the arbitrary constant used in the API usage fee calculation formula was displayed in the constant list 513 on the API usage fee display screen 510 of FIG. 26, it is also possible to display numerical value information other than the arbitrary constant used in the API usage fee calculation formula, or display the API usage fee calculation formula itself. When adopting this kind of configuration, since the basis for calculation of the API usage fee will be displayed in further detail, the transparency of the API provider's service can be further improved.

### (3) Management Tables

The management tables retained by the respective storage units in the API provider system platform 100 and the API connection platform 200 are now explained by illustrating specific examples in FIG. 27 to FIG. 53.

### (3-1) Management Table of the API Connection Platform 200

FIG. 27 is a diagram showing an example of the API request history management table 251. The API request history management table 251 is a management table that is retained in the API request history storage unit 213 of the server 210, and manages the information related to the history of requests for the API that the API connection platform 200 received from the application 300.

As shown in FIG. 27, the API request history management table 251 includes the columns of a request source 2511, a request 2512, a request reception date 2513, a request reception time 2514, a response transmission date 2515, and a response transmission time 2516. The request source 2511 shows the application 300 as the source of the request for the received API, and the request 2512 shows the request for the received API. Moreover, the request reception date 2513 and the request reception time 2514 show the date and the time that the request for the API was received. Moreover, the response transmission date 2515 and the response transmission time 2516 show the date and the time that the response to the request recorded in the record was sent to the application 300.

FIG. 28 is a diagram showing an example of the API specification management table 252. The API specification management table 252 is a management table that is retained in the API request specification storage unit 219 of the server 210, and manages the information related to the specification of each API. As shown in FIG. 28, the API specification management table 252 includes the columns of a request type name 2521 which shows the name of the type of request for the API, a classification 2522 which shows the classification of the requested API, and a data amount 2523 which shows the data amount of the request.

FIG. 29 is a diagram showing an example of the service level management table 253. The service level management table 253 is a management table that is retained in the API request specification storage unit 219 of the server 210, and manages the information related to the service level of the API classification. As shown in FIG. 29, the service level management table 253 includes the columns of an API classification 2531 which shows the classification of the API, and a target latency 2532 which shows the target latency as the service level corresponding to the API classification. Note that the term “latency” means the duration from the time that the API connection platform 200 received the API (request) sent from the API user (application 300) to the time that the API connection platform 200 sends the response to that API, and the service level to be guaranteed is defined by setting the target latency.

FIG. 30 is a diagram showing an example of the constant information management table 254. The constant information management table 254 is a management table that is retained in the constant information storage unit 218 of the server 210, and manages the information related to the various types of constants (arbitrary constants) used in the API usage fee calculation formula for each application 300 that uses the API. The arbitrary constant N (N: natural number) that is used in the API usage fee calculation formula is defined in the contract for each application 300. As shown in FIG. 30, the constant information management table 254 includes the columns of an application 2541, and an arbitrary constant 2542. In the constant information management table 254 of FIG. 30, the arbitrary constant 1 to the arbitrary constant 13 are managed in accordance with the calculation formulas (refer to Formula 1 to Formula 11) of the API usage fee explained in this embodiment.

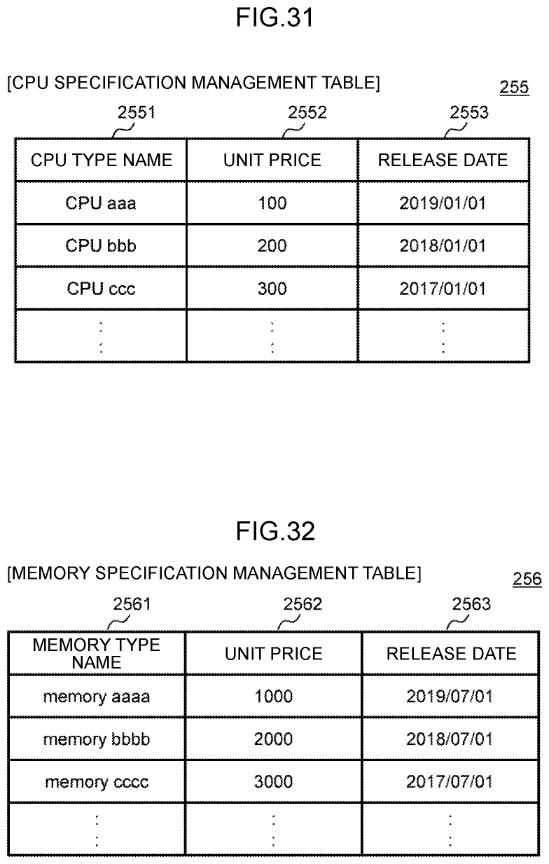

FIG. 31 is a diagram showing an example of the CPU specification management table 255. The CPU specification management table 255 is a management table that is retained in the I/O processing unit specification storage unit 217 of the server 210, and manages the information related to the specification of the CPU installed in the server 210. As shown in FIG. 31, the CPU specification management table 255 includes the columns of a CPU type name 2551 which shows the name of the type of the CPU, a unit price 2552 which shows the price per prescribed unit quantity (number of units) of the CPU, and a release date 2553 which shows the release date of the CPU. The unit price 2552 represents the value of the CPU as one of the data processing resources of the server 210 and, as the numerical value of the unit price is higher, the value thereof is also higher.

FIG. 32 is a diagram showing an example of the memory specification management table 256. The memory specification management table 256 is a management table that is retained in the I/O processing unit specification storage unit 217 of the server 210, and manages the information related to the specification of the memory installed in the server 210. As shown in FIG. 32, the memory specification management table 256 includes the columns of a memory type name 2561 which shows the name of the type of the memory, a unit price 2562 which shows the price per prescribed unit quantity (unit capacity) of the memory, and a release date 2563 which shows the release date of the memory. The unit price 2562 is an index representing the value of the memory as one of the data processing resources of the server 210 and, as the numerical value of the unit price is higher, the value thereof is also higher.

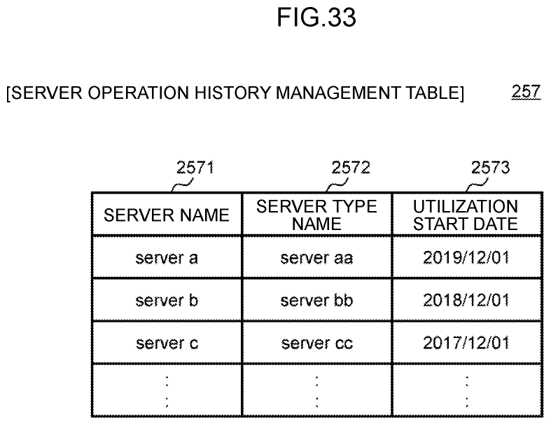

FIG. 33 is a diagram showing an example of the server operation history management table 257. The server operation history management table 257 is a management table that is retained in the server operation history storage unit 214 of the server 210, and manages the operation start date of each server 210 equipped in the API connection platform 200. As shown in FIG. 33, the server operation history management table 257 includes the columns of a server name 2571 which shows the name of the server 210, a server type name 2572 which shows the name of the type of the server 210, and a utilization start date 2573 which shows the date that the utilization of the server 210 was started.

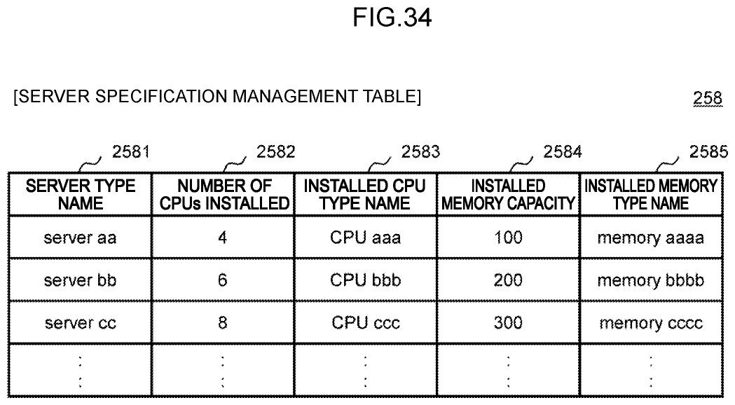

FIG. 34 is a diagram showing an example of the server specification management table 258. The server specification management table 258 is a management table that is retained in the server specification storage unit 216 of the server 210, and manages the information related to the specification of the CPU and the memory in each server 210 equipped in the API connection platform 200. As shown in FIG. 34, the server specification management table 258 includes the columns of a server type name 2581 which shows the name of the type of the server 210, a number of CPUs installed 2582 which shows the number of CPUs installed in the server 210, an installed CPU type name 2583 which shows the name of the type of installed CPU, an installed memory capacity 2584 which shows the capacity of the memory installed in the server 210, and an installed memory type name 2585 which shows the name of the type of the installed memory. Note that the server type name 2581 corresponds to the server type name 2572 of the server operation history management table 257 shown in FIG. 33.

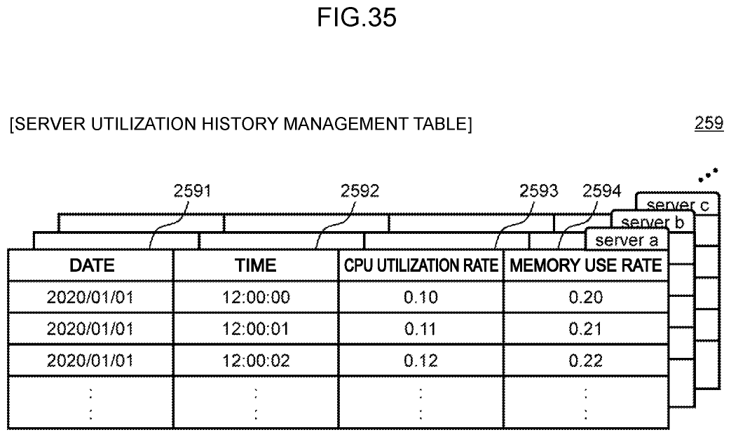

FIG. 35 is a diagram showing an example of the server utilization history management table 259. The server utilization history management table 259 is a management table that is retained in the server utilization log storage unit 215 of the server 210, and manages the information related to the utilization history of each server 210 equipped in the API connection platform 200. As shown in FIG. 35, the server utilization history management table 259 is configured from a table for each server 210 (server type name), and each table includes the columns of a date 2591 which shows the date that the server 210 was utilized, a time 2592 which shows the start time of the utilization, a CPU utilization rate 2593 which shows the CPU utilization rate in the server 210 at the time of the utilization, and a memory use rate 2594 which shows the memory use rate in the server 210 at the time of the utilization.

### (3-2) Management Table of the API Provider System Platform 100

FIG. 36 is a diagram showing an example of the processor management table 151. The processor management table 151 is a management table that is retained in the configuration storage unit 112 of the configuration management device 110, and manages the information related to the device configuration (processor) of the API provider system platform 100. As shown in FIG. 36, the processor management table 151 includes a column of a processor 1511 which shows the device configuration of the API provider system platform 100 as the number of that processor.

FIG. 37 is a diagram showing an example of the write-through coefficient management table 152. The write-through coefficient management table 152 is a management table that is retained in the coefficient correspondence storage unit 113 of the configuration management device 110, and manages the information related to the correspondence of the write-through function setting (valid/invalid) and the write-through coefficient. The write-through coefficient management table 152 includes the columns of a write-through 1521 which shows the write-through function setting (valid/invalid), and a write-through coefficient 1522 which shows the write-through coefficient in which the numerical value thereof is defined in advance in correspondence with the setting. The write-through coefficient is used in the API usage fee calculation formula.

The write-through function is one operational method of the cache memory and, when the write-through function is set to “valid”, the server 120 or the DKC 140 writes data in the FBOF 130 simultaneously with writing data in its own cache at the time of writing data. Furthermore, a response to the data write request is returned only after the writing of data in the FBOF 130 is completed. Meanwhile, when the write-through function is set to “invalid”, the server 120 or the DKC 140 writes data in the FBOF 130 after writing data in its own cache at the time of writing data, and can return a response to the data write request at the time that the data is written in the cache. Upon comparing the valid/invalid of the write-through function, while the data will coincide between the cache and the FBOF 130 when the write-through is valid and there is an advantage in that the control is facilitated on the one hand, there is a drawback in that the latency time of the processor will be longer in comparison to a case when the write-through is invalid. Thus, normally, it is possible to adopt an operation where the write-through function is set to invalid in normal times, and the write-through function is set to valid in abnormal times such as when there is no response from the node.

FIG. 38 is a diagram showing an example of the read direct transfer coefficient management table 153. The read direct transfer coefficient management table 153 is a management table that is retained in the coefficient correspondence storage unit 113 of the configuration management device 110, and manages the information related to the correspondence of the read direct transfer function setting (valid/invalid) and the read direct transfer coefficient. The read direct transfer coefficient management table 153 includes the columns of a read direct transfer 1531 which shows the read direct transfer function setting (valid/invalid), and a read direct transfer coefficient 1532 which shows the read direct transfer coefficient in which the numerical value thereof is defined in advance in correspondence with the setting. The read direct transfer coefficient is used in the API usage fee calculation formula.

To provide an additional explanation regarding the read direct transfer function, in this embodiment, when the read direct transfer function is set to “valid” in the API provider system platform 100, even with the device configuration (processor 3) in which the API provider system platform 100 comprises the DKC 140, the FBOF 130 can directly send the reference data to be read to the server 120 without going through the DKC 140 (refer to step S165 of FIG. 18).

FIG. 39 is a diagram showing an example of the write direct transfer coefficient management table 154. The write direct transfer coefficient management table 154 is a management table that is retained in the coefficient correspondence storage unit 113 of the configuration management device 110, and manages the information related to the correspondence of the write direct transfer function setting (valid/invalid) and the write direct transfer coefficient. The write direct transfer coefficient management table 154 includes the columns of a write direct transfer 1541 which shows the write direct transfer function setting (valid/invalid), and a write direct transfer coefficient 1542 which shows the write direct transfer coefficient in which the numerical value thereof is defined in advance in correspondence with the setting. The write direct transfer coefficient is used in the API usage fee calculation formula.

To provide an additional explanation regarding the write direct transfer function, in this embodiment, when the write direct transfer function is set to “valid” in the API provider system platform 100, even with the device configuration (processor 3) in which the API provider system platform 100 comprises the DKC 140, the server 120 can directly send the update data to be written to the FBOF 130 without going through the DKC 140, and the FBOF 130 can directly send, after the data is updated, the reply to the data update to the server 120 without going through the DKC 140 (refer to step S182 and step S185 of FIG. 24).

FIG. 40 is a diagram showing an example of the server operation history management table 161. The server operation history management table 161 is a management table that is retained in the server operation history storage unit 123 of the server 120, and manages the operation start date of each server 120 equipped in the API provider system platform 100. As shown in FIG. 40, the server operation history management table 161 includes the columns of a server name 1611 which shows the name of the server 120, a server type name 1612 which shows the name of the type of the server 120, and a utilization start date 1613 which shows the date that the utilization of the server 120 was started.

FIG. 41 is a diagram showing an example of the server specification management table 162. The server specification management table 162 is a management table that is retained in the server specification storage unit 125 of the server 120, and manages the information related to the specification of the CPU and the memory in each server 120 equipped in the API provider system platform 100. As shown in FIG. 41, the server specification management table 162 includes the columns of a server type name 1621 which shows the name of the type of the server 120, a number of CPUs installed 1622 which shows the number of CPUs installed in the server 120, an installed CPU type name 1623 which shows the name of the type of installed CPU, an installed memory capacity 1624 which shows the capacity of the memory installed in the server 120, and an installed memory type name 1625 which shows the name of the type of installed memory. Note that the server type name 1621 corresponds to the server type name 1612 of the server operation history management table 161 shown in FIG. 40.

FIG. 42 is a diagram showing an example of the server utilization history management table 163. The server utilization history management table 163 is a management table that is retained in the server utilization log storage unit 124 of the server 120, and manages the information related to the utilization history of each server 120 equipped in the API provider system platform 100. As shown in FIG. 42, the server utilization history management table 163 is configured from a table for each server 120 (server type name), and each table includes the columns of a date 1631 which shows the data that the server 120 was utilized, a time 1632 which shows the start time of the utilization, a CPU utilization rate 1633 which shows the CPU utilization rate in the server 120 at the time of the utilization, a memory use rate 1634 which shows the memory use rate in the server 120 at the time of the utilization, a data read cache hit rate 1635 which shows the cache hit rate in the read processing performed by the server 120 targeting the data stored in the FBOF 130, a write-through 1636 which shows the write-through function setting (valid/invalid) in the server 120, a read direct transfer 1637 which shows the read direct transfer function setting (valid/invalid) in the server 120, and a write direct transfer 1638 which shows the write direct transfer function setting (valid/invalid) in the server 120.

FIG. 43 is a diagram showing an example of the CPU specification management table 164. The CPU specification management table 164 is a management table that is retained in the I/O processing unit specification storage unit 126 of the server 120, and manages the information related to the specification of the CPU installed in the server 120. As shown in FIG. 43, the CPU specification management table 164 includes the columns of a CPU type name 1641 which shows the name of the type of the CPU, a unit price 1642 which shows the price per prescribed unit quantity (number of units) of the CPU, and a release date 1643 which shows the release date of the CPU. The unit price 1642 is an index representing the value of the CPU as one of the data processing resources of the server 120 and, as the numerical value of the unit price is higher, the value thereof is also higher.

FIG. 44 is a diagram showing an example of the memory specification management table 165. The memory specification management table 165 is a management table that is retained in the I/O processing unit specification storage unit 126 of the server 120, and manages the information related to the specification of the memory installed in the server 120. As shown in FIG. 44, the memory specification management table 165 includes the columns of a memory type name 1651 which shows the name of the type of the memory, a unit price 1652 which shows the price per prescribed unit quantity (unit capacity) of the memory, and a release date 1653 which shows the release date of the memory. The unit price 1652 is an index representing the value of the memory as one of the data processing resources of the server 120 and, as the numerical value of the unit price is higher, the value thereof is also higher.

FIG. 45 is a diagram showing an example of the FBOF operation history management table 171. The FBOF operation history management table 171 is a management table that is retained in the FBOF operation history storage unit 133 of the FBOF 130, and manages the operation start date of each FBOF 130 equipped in the API provider system platform 100. As shown in FIG. 45, the FBOF operation history management table 171 includes the columns of an FBOF name 1711 which shows the name of the FBOF 130, an FBOF type name 1712 which shows the name of the type of the FBOF 130, and a utilization start date 1713 which shows the date that the utilization of the FBOF 130 was started.

FIG. 46 is a diagram showing an example of the FBOF specification management table 172. The FBOF specification management table 172 is a management table that is retained in the FBOF specification storage unit 135 of the FBOF 130, and manages the information related to the specification of the CPU in each FBOF 130 equipped in the API provider system platform 100. As shown in FIG. 46, the FBOF specification management table 172 includes the columns of an FBOF type name 1721 which shows the name of the type of the FBOF 130, a number of CPUs installed 1722 which shows the number of CPUs installed in the FBOF 130, and an installed CPU type name 1723 which shows the name of the type of the installed CPU. Note that the FBOF type name 1721 corresponds to the FBOF type name 1712 of the FBOF operation history management table 171 shown in FIG. 45.

FIG. 47 is a diagram showing an example of the FBOF utilization history management table 173. The FBOF utilization history management table 173 is a management table that is retained in the FBOF utilization log storage unit 134 of the FBOF 130, and manages the information related to the utilization history of each FBOF 130 equipped in the API provider system platform 100. As shown in FIG. 47, the FBOF utilization history management table 173 is configured from a table for each FBOF 130 (FBOF type name), and each table includes the columns of a date 1731 which shows the date that the FBOF 130 was utilized, a time 1732 which shows the start time of the utilization, a CPU utilization rate 1733 which shows the CPU utilization rate in the FBOF 130 at the time of the utilization, a read direct transfer 1734 which shows the read direct transfer function setting (valid/invalid) in the FBOF 130, and a write direct transfer 1735 which shows the write direct transfer function setting (valid/invalid) in the FBOF 130.

FIG. 48 is a diagram showing an example of the CPU specification management table 174. The CPU specification management table 174 is a management table that is retained in the I/O processing unit specification storage unit 136 of the FBOF 130, and manages the information related to the specification of the CPU installed in the FBOF 130. As shown in FIG. 48, CPU specification management table 174 includes the columns of a CPU type name 1741 which shows the name of the type of the CPU, a unit price 1742 which shows the price per prescribed unit quantity (number of units) of the CPU, and a release date 1743 which shows the release date of the CPU. The unit price 1742 is an index representing the value of the CPU as one of the data processing resources of the FBOF 130 and, as the numerical value of the unit price is higher, the value thereof is also higher.

FIG. 49 is a diagram showing an example of the DKC operation history management table 181. The DKC operation history management table 181 is a management table that is retained in the DKC operation history storage unit 143 of the DKC 140, and manages the operation start date of each DKC 140 equipped in the API provider system platform 100. As shown in FIG. 49, the DKC operation history management table 181 includes the columns of a DKC name 1811 which shows the name of the DKC 140, a DKC type name 1812 which shows the name of the type of the DKC 140, and a utilization start date 1813 which shows the date that the utilization of the DKC 140 was started.

FIG. 50 is a diagram showing an example of the DKC specification management table 182. The DKC specification management table 182 is a management table that is retained in the DKC specification storage unit 145 of the DKC 140, and manages the information related to the specification of the CPU and the memory in each DKC 140 equipped in the API provider system platform 100. As shown in FIG. 50, the DKC specification management table 182 includes the columns of a DKC type name 1821 which shows the name of the type of the DKC 140, a number of CPUs installed 1822 which shows the number of CPUs installed in the DKC 140, an installed CPU type name 1823 which shows the name of the type of installed CPU, an installed memory capacity 1824 which shows the capacity of the memory installed in the DKC 140, and an installed memory type name 1825 which shows the name of the type of installed memory. Note that the DKC type name 1821 corresponds to the DKC type name 1812 of the DKC operation history management table 181 shown in FIG. 49.

FIG. 51 is a diagram showing an example of the DKC utilization history management table 183. The DKC utilization history management table 183 is a management table that is retained in the DKC utilization log storage unit 144 of the DKC 140, and manages the information related to the utilization history of each DKC 140 equipped in the API provider system platform 100. As shown in FIG. 51, the DKC utilization history management table 183 is configured from a table for each DKC 140 (DKC type name), and each table includes the columns of a date 1831 which shows the date that the DKC 140 was utilized, a time 1832 which shows the start time of the utilization, a CPU utilization rate 1833 which shows the CPU utilization rate in the DKC 140 at the time of the utilization, a memory use rate 1834 which shows the memory use rate in the DKC 140 at the time of the utilization, a data read cache hit rate 1835 which shows the cache hit rate in the read processing performed by the DKC 140 targeting the data stored in the FBOF 130, a write-through 1836 which shows the write-through function setting (valid/invalid) in the DKC 140, a read direct transfer 1837 which shows the read direct transfer function setting (valid/invalid) in the DKC 140, and a write direct transfer 1838 which shows the write direct transfer function setting (valid/invalid) in the DKC 140.

FIG. 52 is a diagram showing an example of the CPU specification management table 184. The CPU specification management table 184 is a management table that is retained in the I/O processing unit specification storage unit 146 of the DKC 140, and manages the information related to the specification of the CPU installed in the DKC 140. As shown in FIG. 52, the CPU specification management table 184 includes the columns of a CPU type name 1841 which shows the name of the type of the CPU, a unit price 1842 which shows the price per prescribed unit quantity (number of units) of the CPU, and a release date 1843 which shows the release date of the CPU. The unit price 1842 is an index representing the value of the CPU as one of the data processing resources of the DKC 140 and, as the numerical value of the unit price is higher, the value thereof is also higher.

FIG. 53 is a diagram showing an example of the memory specification management table 185. The memory specification management table 185 is a management table that is retained in the I/O processing unit specification storage unit 146 of the DKC 140, and manages the information related to the specification of the memory installed in the DKC 140. As shown in FIG. 53, the memory specification management table 185 includes the columns of a memory type name 1851 which shows the name of the type of the memory, a unit price 1852 which shows the price per prescribed unit quantity (unit capacity) of the memory, and a release date 1853 which shows the release date of the memory. The unit price 1852 is an index representing the value of the memory as one of the data processing resources of the DKC 140 and, as the numerical value of the unit price is higher, the value thereof is also higher.

As explained above, as a result of the API billing system 1 according to this embodiment determining the API usage fee (billing amount) based on the request for the API from the application 300 and the history of the response thereof, and the data processing resource amount and the value thereof in the API billing system 1 (in particular the API provider system platform 100) used pursuant to the provision of the API as a result of executing the API usage fee determination processing and the API usage fee calculation formula shown in FIG. 25, the API billing system 1 can thereby flexibly change the billing amount according to the resource amount and the value of the data processing resources in the service provider's system platform at the time that the API was provided. Specifically, for example, when numerous data processing resources or highly valuable data processing resources are used in the API processing, the API usage fee can be set higher.

In particular, since the data processing resource amount and the value thereof in the API billing system 1 can be determined based on the specification and utilization history of the respective nodes (server, DKC, FBOF) configuring the API provider system platform 100, even when the API provider system platform 100 is provided with an IT infrastructure solution or the like which enables the prompt expansion of performance by adding data processing resources as described in paragraph [0005], the API usage fee (billing amount) can be flexibly changed by giving consideration to the dynamically changing data processing resource amount and the value thereof.

For example, in this embodiment, the API processing in response to the request is executed by different processors (processor 1 to processor 3) according to the device configuration of the API provider system platform 100. Thus, the routine of the API processing will differ depending on the device configuration of the API provider system platform 100 (refer to FIG. 4 to FIG. 24), and differences will arise in the amount of resources used in the respective nodes (server 120, FBOF 130, DKC 140). Thus, in this embodiment, the API usage fee is determined based on the specification and the utilization history of the device configuration corresponding to the processor that executed the API processing.

Moreover, in this embodiment, the API processing in response to the request will have a different routine depending on whether the requested API is a reference system API or an update system API, and differences will arise in the amount of resources used in the respective nodes (server 120, FBOF 130, DKC 140). Thus, in this embodiment, the API usage fee is determined based on different calculation methods in cases where the requested API is a reference system API and in cases where the requested API is an update system API. Specifically, the data processing resource amount of the reference system API and the value thereof and the data processing resource amount of the update system API and the value thereof are calculated using different calculation formulas (refer to Formula 2 to Formula 6 and Formula 7 to Formula 11 of the API usage fee calculation formula), the reference system API usage fee and the update system API usage fee are separately calculated from the respective calculation results, and ultimately the calculated reference system API usage fee and update system API usage fee are totaled to determine the API usage fee (refer to Formula 1).

Moreover, the method of the API processing in response to the request will also differ depending on the setting of valid/invalid of the read direct transfer function and the write direct transfer function that can be set by introducing the IT infrastructure solution which enables the prompt expansion of performance by adding data processing resources as described in paragraph [0005] to the API provider system platform 100. More specifically, when the reference system API is requested, the method of the API processing will differ irrespective of whether the read direct transfer function has been set to “valid” (refer to FIG. 14 to FIG. 19), and, when the update system API is requested, the method of the API processing will differ irrespective of whether the write direct transfer function has been set to “valid” (refer to FIG. 20 to FIG. 24). Otherwise, when the update system API is requested, the method of the API processing will differ irrespective of whether the write-through function has been set to “valid” (refer to FIG. 11 to FIG. 13, and FIG. 20 to FIG. 22). Accordingly, with the API provider system platform 100, the method of the API processing will differ depending on the setting of the data transfer function, and, therefore, differences will arise in the amount of resources used in the respective nodes (server 120, FBOF 130, DKC 140) of the API provider system platform 100. However, in this embodiment, by giving consideration to the foregoing points, the setting of the data transfer function is included in the determinant factors of the API usage fee (refer to Formula 6, Formula 8, and Formula 11 of the API usage fee calculation formula).

Here, the influence that the setting of the data transfer function has on the API usage fee is now additionally explained by taking the write direct transfer function as an example. In the API billing system 1, when the API processing is performed by the processor 3 in response to the request for the update system API when the write direct transfer function is “valid”, and, as explained in step S182 of FIG. 24, since the server 120 will directly send the data update instruction and the updated data to the FBOF 130 via the DKC 140, the load on the DKC 140 can be reduced in comparison to a case when the write direct transfer function is “invalid” (FIG. 21, FIG. 22), and the effect of suppressing an overload in the API provider system platform 100 can be expected. Thus, when the write direct transfer function is “valid”, it is assumed that the API provider will wish to lower the usage fee for the use of the update system API in comparison to a case when the write direct transfer function is “invalid”. In response to such wish, in this embodiment, the numerical value of the sum of the “data processing resource amount of DKC and value thereof” and the “data processing resource amount of FBOF and value thereof” in Formula 8 of the API usage fee calculation formula will change in proportion to the write direct transfer coefficient. However, according to the write direct transfer coefficient management table 154 shown in FIG. 39, the write direct transfer coefficient when the read direct transfer function is “valid” is “0.5”, and the write direct transfer coefficient when the read direct transfer function is “invalid” is “1”. Accordingly, if the update system API is used when the write direct transfer function is valid, the data processing resource amount of the DKC and the FBOF and the value thereof will decrease by half in comparison to a case when the write direct transfer function is “invalid”, and consequently the update system API usage fee (and ultimately the API usage fee) will decrease. In other words, the API billing system 1 can flexibly change the API usage fee in response to the foregoing wish of the API provider. Note that, while the write direct transfer function was explained as an example above, it is evident that the API usage fee can be similarly changed in the case of the read direct transfer function or the write-through function by referring to the API usage fee calculation formula or the management tables shown in FIG. 37 and FIG. 38.

Moreover, in this embodiment, as a result of using the arbitrary constant 1 in Formula 1 of the API usage fee calculation formula, a different API usage fee can be calculated for each application 300.

Furthermore, since the API billing system 1 according to this embodiment can display the information used in the calculation of the calculated API usage fee on the API usage fee display screen 510 shown in FIG. 26 as well as present the breakdown of the billing and details of the basis for calculation thereof to the API user, the API user can recognize the data processing resource amount and the value thereof required for the processing of each API, and know the cost that is being expended for maintaining the service level (target latency). Consequently, as a result of the transparency of the API provider's service being improved, the API user's reliability in the API provider will improve, and improvement in the customer satisfaction can be expected.

### REFERENCE SIGNS LIST

1 API billing system
100 API provider system platform
110 configuration management device
111, 121, 131, 141, 211 communication I/F unit
112 configuration storage unit
113 coefficient correspondence storage unit
120 server
122, 132, 142, 212 I/O processing unit
123, 214 server operation history storage unit
124, 215 server utilization log storage unit
125, 216 server specification storage unit
126, 136, 146, 217 I/O processing unit specification storage unit
130 FBOF
133 FBOF operation history storage unit
134 FBOF utilization log storage unit
135 FBOF specification storage unit
140 DKC
143 DKC operation history storage unit
144 DKC utilization log storage unit
145 DKC specification storage unit
151 processor management table
152 write-through coefficient management table
153 read direct transfer coefficient management table
154 write direct transfer coefficient management table
161, 257 server operation history management table
162, 258 server specification management table
163, 259 server utilization history management table
164, 174, 184, 255 CPU specification management table
165, 185, 256 memory specification management table 171 FBOF operation history management table 172 FBOF specification management table 173 FBOF utilization history management table 181 DKC operation history management table 182 DKC specification management table 183 DKC utilization history management table 200 API connection platform 210 server 213 API request history storage unit 218 constant information storage unit 219 API request specification storage unit 220 API usage fee calculation unit 251 API request history management table 252 API specification management table 253 service level management table 254 constant information management table 300 application 410, 420, 430 network 510 API usage fee display screen

1. An API billing system, comprising:
an API provider system platform having an API server which provides an API; and
an API connection platform which mediates an application using the API and the API provider system platform, and manages the API,
wherein:
the API provider system platform is configured such that a storage apparatus, or a storage controller which controls the storage apparatus, can be added to a device configuration in addition to the API server;
the API provider system platform executes processing of the API requested from the application with a processor which differs according to the device configuration of the API provider system platform; and
the API connection platform calculates an API usage fee for use of the API by the application based on a specification and a utilization history of each device included in the processor upon execution of the processing of the API.

2. The API billing system according to claim 1,
wherein the API connection platform calculates the API usage fee by including, in a calculation factor, a resource amount and a value of data processing resources in each of the devices included in the processor which were used for the processing of the API.

3. The API billing system according to claim 2,
wherein the API connection platform calculates the resource amount and the value of the data processing resources which were used for the processing of a reference system API when the reference system API is requested from the application, and calculates the resource amount and the value of the data processing resources which were used for an update system API when the update system API is requested from the application, based on different calculation methods, respectively, and calculates the API usage fee using the two calculated resource amounts and values of the data processing resources.

4. The API billing system according to claim 3,
wherein, when the API provider system platform includes the API server, the storage apparatus and the storage controller, and a read direct transfer function of directly sending data read by the storage apparatus to the API server without going through the storage controller can be set,
the API connection platform includes, in a calculation factor, a setting of the read direct transfer function when the reference system API is requested from the application, and calculates the resource amount and the value of the data processing resources which were used for the processing of the reference system API in the calculation of the API usage fee.

5. The API billing system according to claim 3,
wherein, when the API provider system platform includes the API server, the storage apparatus and the storage controller, and a write direct transfer function of directly sending data to be updated by the storage apparatus from the API server to the storage apparatus without going through the storage controller can be set,
the API connection platform includes, in a calculation factor, a setting of the write direct transfer function when the update system API is requested from the application, and calculates the resource amount and the value of the data processing resources which were used for the processing of the update system API in the calculation of the API usage fee.

6. The API billing system according to claim 3,
wherein, when the API provider system platform includes at least the API server and the storage apparatus, and a write-through function of the API server returning a response to a request for writing data after the storage apparatus completes the writing of the data can be set,
the API connection platform includes, in a calculation factor, a setting of the write-through function when the update system API is requested from the application, and calculates the resource amount and the value of the data processing resources which were used for the processing of the update system API in the calculation of the API usage fee.

7. The API billing system according to claim 1,
wherein the API connection platform outputs the calculated API usage fee together with detailed information related to the calculation of the API usage fee.

8. The API billing system according to claim 7,
wherein the detailed information includes an API usage fee for use of the reference system API and an API usage fee for use of the update system API.

9. The API billing system according to claim 7,
wherein the detailed information includes includes information related to a prescribed constant which is predetermined for each of the applications among coefficients used in the calculation of the API usage fee.

10. The API billing system according to claim 1,
wherein the storage apparatus is an FBOF (Fabric-attached Bunch Of Flash).

11. An API billing management method to be performed by an API billing system including an API provider system platform having an API server which provides an API, and an API connection platform which mediates an application using the API and the API provider system platform, and manages the API,
wherein the API provider system platform is configured such that a storage apparatus, or a storage controller which controls the storage apparatus, can be added to a device configuration in addition to the API server, and
wherein the API billing management method comprises:
an API processing step of the API provider system platform executing processing of the API requested from the application with a processor which differs according to the device configuration of the API provider system platform; and
an API usage fee calculation step of the API connection platform calculating an API usage fee for use of the API by the application based on a specification and a utilization history of each device included in the processor upon execution of the processing of the API.

12. The API billing management method according to claim 11,
wherein, in the API usage fee calculation step, the API connection platform calculates the API usage fee by including, in a calculation factor, a resource amount and a value of data processing resources in each of the devices included in the processor which were used for the processing of the API.

13. The API billing management method according to claim 11, further comprising:
an output step of the API connection platform outputting the API usage fee calculated in the API usage fee calculation step together with detailed information related to the calculation of the API usage fee.

14. The API billing management method according to claim 13,
wherein the detailed information output in the output step includes information related to a prescribed constant which is predetermined for each of the applications among coefficients used in the calculation of the API usage fee.
